(19) United States
(12) Patent Application Publication
(10) Pub. No.: US 2026/0225927 A1
(43) Pub. Date: Aug. 6, 2026

(54) ALTERING PROPERTIES OF A FLUID AND MAGNETICALLY ASSISTED DESALINATION

(71) Applicant: UNIVERSITY OF WYOMING, Laramie, WY (US)

(72) Inventor: Jonathan BRANT, Laramie, WY (US)

(21) Appl. No.: 19/154,413

(22) PCT Filed: Feb. 7, 2024
(86) PCT No.: PCT/US2024/014690

§ 371 Date: Aug. 7, 2025

Related U.S. Application Data
(60) Provisional application No. 63/443,920, filed on Feb. 7, 2023.

(51) Int. Cl. C02F 1/48; B03C 1/023; B03C 1/30; C02F 1/44

(52) U.S. Cl. CPC C02F 1/482; B03C 1/023; B03C 1/30; C02F 1/441; B03C 2201/18; C02F 2201/005; C02F 2209/09; C02F 2301/046

(57) ABSTRACT

Embodiments of the present disclosure generally relate to desalination, and more specifically to apparatus and methods for magnetically assisted desalination. In an embodiment is provided an apparatus adapted to desalinate a fluid. The apparatus includes a fluid passage comprising a first end, a second end, and a flow path coupling the first end with the second end. The apparatus further includes a valve coupled to the first end, the valve adapted to permit a fluid to enter the flow path. The apparatus further includes a device adapted to form a magnetic field, the device positioned on an exterior of the fluid passage. The apparatus further includes a selective membrane coupled to a second end of the flow path.

### FIELD

Embodiments of the present disclosure generally relate to altering properties of a fluid and to desalination, and more specifically to apparatus and methods for magnetically assisted desalination.

### BACKGROUND

Conventional technologies for desalination have focused on reducing the specific energy consumption or increasing the performance of membrane-based desalination processes in various ways. Some conventional technologies focus on the development of highly water permeable membranes using nanocomposite structures and/or hydrophilic polymers, or target the thickness of the salt rejecting active layer of composite membranes. Other conventional technologies focus on creating membranes out of 2D materials (such as graphene, among others) to develop atomically thin separating layers. Still other conventional technologies have been devoted to energy recovery devices that transfer or recover the applied hydraulic pressure to reduce the energy consumption of the primary feed pump. Conventional technologies have also turned to the use of osmotic agents (such as salts) in the permeate phase to reduce the net pressure that must be overcome to permeate water across the membrane. Although such technologies have led to higher-performance membranes and reduced specific energy consumption, the technologies are limited.

There is a need for new and improved apparatus and methods for desalination.

### SUMMARY

Embodiments of the present disclosure generally relate to altering properties of a fluid and to desalination, and more specifically to apparatus and methods for magnetically assisted desalination. Unlike conventional technologies, embodiments described herein can enhance (increase) water transport across membranes by manipulating the properties of water molecules. Embodiments described herein can, for example, be characterized as having a reduced specific energy consumption and/or reduced equipment footprint relative to conventional technologies.

In an embodiment, an apparatus for altering at least one property of a fluid is provided. The apparatus includes a fluid passage comprising a first end, a second end, and a flow path coupling the first end with the second end. The apparatus further includes a device adapted to form a magnetic field, the device positioned on an exterior of the fluid passage.

In another embodiment, a desalination apparatus is provided. The desalination apparatus includes a fluid passage comprising a first end, a second end, and a flow path coupling the first end with the second end. The desalination apparatus further includes a valve coupled to the first end, the valve adapted to permit a fluid to enter the flow path. The desalination apparatus further includes a device adapted to form a magnetic field, the device positioned on an exterior of the fluid passage. The desalination apparatus further includes a selective membrane coupled to a second end of the flow path.

In another embodiment, an apparatus adapted to alter at least one property of a fluid is provided. The apparatus includes a housing comprising first end, a second end, and a flow path through which a fluid is adapted to flow, the flow path connecting the first end and the second end. The apparatus further includes a magnetic field source positioned on an exterior of the housing between the first end and the second end, the magnetic field source adapted to produce a magnetic field. The apparatus further includes a first valve coupled to a first inlet of the first end of the housing, the first valve adapted to permit the fluid to enter the flow path. The apparatus further includes a second valve coupled to a first outlet of the second end of the housing, the second valve adapted to permit a magnetically treated fluid to exit the apparatus. The apparatus further includes a recycle line coupled to a second outlet of the second end and to a second inlet of the first end, the recycle line adapted to recirculate the magnetically treated fluid through the flow path.

In another embodiment, a method for altering at least one property of a fluid is provided. The method includes directing a fluid to flow through a magnetic field and exposing the fluid, a solute therein, or combinations thereof to the magnetic field to form a treated fluid.

In another embodiment, a method for desalinating a fluid is provided. The method includes directing a fluid to flow through a magnetic field. The method further includes exposing the fluid, a solute therein, or combinations thereof to the magnetic field to form a treated fluid. The method further includes directing the treated fluid to flow through a selective membrane.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A illustrates an example flow-through magnetic apparatus according to at least one embodiment of the present disclosure.

FIG. 1B illustrates a membrane-magnetic field apparatus according to at least one embodiment of the present disclosure.

FIG. 1C illustrates a membrane-magnetic field apparatus according to at least one embodiment of the present disclosure.

FIGS. 2A-2D show various views of a section of a flow-through magnetic field device according to at least one embodiment of the present disclosure.

FIG. 2E shows an illustration of the magnetic field flux density created by a section of a flow-through magnetic field device according to at least one embodiment of the present disclosure.

FIGS. 2F and 2G show changes in magnetic field direction and changes in magnetic field flux density, respectively, created by a flow-through magnetic field device according to at least one embodiment of the present disclosure. The arrow shows the direction of fluid flow through the flow-through magnetic field device.

FIG. 3 is an illustration of a section of the multidirectional magnetic field highlighting the magnetic flux (B) and direction of the magnetic fields according to at least one embodiment of the present disclosure. The direction of the magnetic field at each point is shown by the direction of the arrow.

FIG. 4A shows non-limiting data comparing mean permeance values measured for a TriSep 1812 Sanitary Element, ACM1 reverse osmosis (RO) membrane in a spiral wound configuration according to at least one embodiment of the present disclosure.

FIG. 4B shows non-limiting permeate flowrate data for an ACM5 (RO) membrane treating ultrapure water recycled through a flow-through magnetic apparatus according to at least one embodiment of the present disclosure.

FIG. 5 shows non-limiting data for normalized water flux through an SW30HR RO membrane for water that had passed through a flow-through magnetic apparatus at different flow velocities according to at least one embodiment of the present disclosure.

FIG. 6 shows non-limiting data for normalized water flux through an SW30HR RO membrane as a function of time after passage through a flow-through magnetic apparatus according to at least one embodiment of the present disclosure.

FIG. 7 is a plot showing non-limiting data for measured change in dynamic viscosity, μ, of water after having passed through a flow-through magnetic apparatus at different flow velocities according to at least one embodiment of the present disclosure.

FIG. 8 is a plot showing the predicted (theoretical) water flux across a RO membrane as a function of dynamic viscosity of water according to at least one embodiment of the present disclosure.

FIG. 9 shows an ion-water complex illustrating solvation shells of a sodium ion (Na⁺) dissolved in water (H₂O).

FIGS. 10A and 10B show non-limiting data for passage of a mixed electrolyte solution through a SW30HR membrane after exposure of the mixed electrolyte solution to a magnetic field produced by a flow-through magnetic apparatus according to at least one embodiment of the present disclosure.

FIG. 11A shows non-limiting data of magnetic energy (shown as open circles) for calcium ion as a function of flow velocity (primary x-axis on the left) through a flow-through magnetic apparatus according to at least one embodiment of the present disclosure. The energies (shown as hatched bars) for calcium ion to achieve different levels of hydration (solvation) are plotted on the secondary x-axis on the right according to at least one embodiment of the present disclosure.

FIG. 11B shows non-limiting data of magnetic energy (shown as open circles) for magnesium ion as a function of flow velocity (primary x-axis on the left) through a flow-through magnetic apparatus according to at least one embodiment of the present disclosure. The energies (shown as hatched bars) for magnesium ion to achieve different levels of hydration (solvation) are plotted on the secondary x-axis on the right according to at least one embodiment of the present disclosure.

Figures included herein illustrate various embodiments of the disclosure. It is contemplated that elements and features of one embodiment may be beneficially incorporated in other embodiments without further recitation.

### DETAILED DESCRIPTION

Embodiments of the present disclosure generally relate to altering properties of a fluid and to desalination, and more specifically to apparatus and methods for magnetically assisted desalination. The inventor has found apparatus and methods for, e.g., increasing water transport across membranes. Unlike conventional technologies, embodiments described herein can enhance (increase) water transport across membranes by, for example, manipulating properties of water molecules. In some embodiments, embodiments of the present disclosure can be utilized to, for example, transform and/or alter properties of water and/or solutes therein. By transforming and/or altering properties of the water and/or the solutes therein, the specific energy (as measured in kilowatt-hour per cubic meter, kWh/m³) consumption and/or equipment footprint can be reduced relative to conventional membrane-based desalination processes.

Embodiments described herein can utilize magnet(s), such as permanent magnet(s), that are arranged in or about a flow-through tube. The arrangement can create a multi-directional magnetic field. This field can be integrated with, for example, an electromagnetic wave generator by which electromagnetic waves are propagated through the flow-through tube and through the multi-directional magnetic field(s). These fields and waves can impart energy on the media (fluid) that is passing through them. For example, water molecules that pass through the apparatus described herein can be exposed to a magnetic energy(ies). The magnitude of this magnetic energy(ies) can be a function of, for example, media properties (for example, temperature, composition), velocity through apparatus described herein, field/wave properties (strength, field gradient, number of fields, wavelength, wave form), combinations thereof, among other parameters.

Embodiments described herein can enable enhanced fluid transport (permeability) across membranes. For example, the inventor has demonstrated, in some embodiments, that passing water through the apparatus described herein results in enhanced water transport (permeability) across salt-rejecting membranes, such as reverse osmosis (RO) membranes. Non-limiting model studies indicate that the enhanced permeability can result from, for example, changes in the bond properties and charge distribution across the water molecular structure. These changes can, in turn, alter the bonding and structure properties of water molecules which can manifest itself as reduced dynamic viscosity and other effects that allow the water to more easily transport through the separating layer(s) of salt rejecting membranes.

Conventional technologies for desalination have focused on reducing the specific energy consumption or increasing the performance of membrane-based desalination processes in various ways. Some conventional technologies focus on the development of highly water permeable membranes using nanocomposite structures and/or hydrophilic polymers, or target the thickness of the salt rejecting active layer of composite membranes. Other conventional technologies focus on creating membranes out of 2D materials (such as graphene, covalent organic frameworks, and metal organic frameworks, among others) to develop atomically thin separating layers. Still other conventional technologies have been devoted to energy recovery devices that transfer or recover the applied hydraulic pressure to reduce the energy consumption of the primary feed pump. Conventional technologies have also turned to the use of osmotic agents (such as salts) in the permeate phase to reduce the net pressure that must be overcome to permeate water across the membrane. These conventional technologies, however, are limited.

Embodiments described herein are a departure from these approaches. For example, embodiments of the present disclosure can manipulate or alter the water itself. For example, and in contrast to conventional technologies for desalination, embodiments described herein can enable modification of the permeating phase (for example, aqueous fluid such as water) to enhance its transport across and/or through a salt-rejecting membrane. Such alterations can arise from changes in the electron distribution around the water molecular structure which, in turn, can affect how water molecules interact with one another and with other media like the materials (for example, polymers) that make up a membrane.

As used herein, the term “transform” can include conversion of a compound, molecule, and/or ion into another, often more simple (in terms of, for example, its structure) compound, molecule, and/or ion. In some embodiments, the term “transform” includes altering, modifying, dehydrating, and/or otherwise changing the chemical properties and/or physical properties of a substance. Transformation can include a structural change and/or degradation of a substance. For example, embodiments described herein can be utilized for altering properties of molecules and transforming molecules. Embodiments described herein can also be utilized to dehydrate ions. Dehydrating an ion means that the ion loses a portion of its hydration shell/solvation layers. Removal of these layers then can, in turn, affect the behavior of the ion, for example, solubility in water, pairing with a counter ion during precipitate/scale formation, etc.

As used herein, the term “substance” refers to any known state of matter such as a solid, liquid, gas, and plasma. As used herein, the term “target” refers to a substance, a material, a molecule, a compound, ion thereof, or combinations thereof that can be targeted by a source of magnetic energy, a magnetic device, or a magnetic system for, e.g., treatment, transformation, alteration, dehydration, change, etc. The target can, for example, be water, an inorganic target, or combinations thereof. As used herein, the term “inorganic target” can include an inorganic substance, an inorganic material, an inorganic molecule, an inorganic compound, ion thereof, or combinations thereof that can be targeted by a source of magnetic energy, a magnetic device, or a magnetic system for, e.g., treatment, transformation, alteration, dehydration, change, etc.

Embodiments described herein can be utilized to change one or more properties of a fluid or component thereof, such as viscosity and surface tension, among other properties. This can arise due to the changes in the bond properties of the molecules as described herein.

Embodiments described herein can be utilized to treat a substance. Treating a substance can include altering properties of substances, transforming substances, mineralizing substances, removing substances, destroying substances, dissociating substances, dehydrating substances, or combinations thereof. Treating a substance can include exposing a substance to a magnetic field or a magnetic energy such that the substance is transformed. Treating a substance can include introducing a substance with a magnetic field or a magnetic energy such that the substance is transformed.

In some embodiments, the magnetic field or magnetic energy is sourced from a magnetic device to form the magnetic field or the magnetic energy, the magnetic device comprising one or more magnets such as permanent magnets. As described further below, apparatus described herein can be used to change a molecular property and/or atomic property of the target (such as water, a salt, an ion thereof, or combinations thereof) for the purpose of, for example, changing a specific physicochemical characteristic (mesoscale property) of the substance. In some embodiments, “molecular property” includes a property that is intrinsic to a molecule such as bond length, bond energy, bond angle, spin state, energy state, polarizability, or combinations thereof, among others. Transformation of a molecular property(ies) is a change from the ambient or normal molecular property. In some embodiments, “mesoscale property” refers to physicochemical properties of a substance at a Newtonian scale. Such mesoscale properties can include, but are not limited to, hydrogen bonding, viscosity, dynamic viscosity, permeability, solubility, density, surface tension, polarity, pH, conductivity, reactivity, thermal conductivity, enthalpy, entropy, boiling point, vapor point, or combinations thereof, among others. Transformation of a mesoscale property(ies) is a change from the ambient or normal mesoscale property. Transformation of a mesoscale property(ies) of a substance can be performed by transformation of the substance's molecular property(ies). For example, change in energy states results in bond angle differences of water molecules at molecular scale and changes in the viscosity of the water at the Newtonian scale (mesoscale).

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### Examples

The examples include, for example, embodiments of apparatus for altering properties of water. A non-limiting objective of the examples described herein includes evaluating changes in water permeance for a commercial RO membrane following passage through a multi-directional magnetic field. Changes in, for example, the dynamic viscosity of water were also investigated and correlated with changes in water transport across the RO membrane. By using embodiments described herein, the energy consumption of, for example, RO-based desalination processes, can be reduced.

Results described herein indicate that embodiments of the present disclosure can be utilized to alter various properties of water and/or solutes therein. Magnitudes of these changes can be a function of energy and fluid velocity through a magnetic field. Changes in, for example, bond energy, bond angles, bond lengths, spin states, energy states, polarizability, hydration shell, or combinations thereof, can affect the nature of water clusters and transport through nanoconfinements (such as selective membranes).

The non-limiting data indicate that the dynamic viscosity of water can be decreased upon flowing the water through a multi-directional magnetic field produced by embodiments described herein. This reduction in dynamic viscosity can be a function of the water's flow velocity through the magnetic field. In addition, the non-limiting data indicate that water and salt permeabilities can be increased across salt-rejecting membranes following passage through a multi-directional magnetic field produced by embodiments described herein. Magnitudes of these changes can be a function of the fluid's flow velocity through the magnetic field. Under the conditions tested, changes may be temporary and may return to a baseline condition approximately 4-8 hours after passing through the magnetic field. Further, the non-limiting results indicate that changes in ion permeability may be designed based on, for example, the design and/or operation of apparatus described herein.

### 1. Introduction

The use of magnetic fields to cause changes in the properties of aqueous media presents new opportunities for improving the performance of membrane systems. Example applications have included control of mineral scaling in desalination processes, improvements in ion exchange kinetics, and water permeation through reverse osmosis (RO) membranes.

While showing tremendous promise, the ability of magnetic fields to create such changes in material properties is not without controversy. Much of this disagreement, and impediment to magnetic field technologies, may be traced to the lack of detailed understanding of water properties and how changes to these characteristics are related to those of the applied magnetic field(s).

Recent efforts in material science that have resulted in novel membranes, are limited by thermodynamics and physics resulting in desalination specific energy consumption (kWh/m³) values just above the thermodynamic minimum. Other separation processes are similarly limited because of a singular focus on improving material properties without considering radically different avenues by which to affect the properties of the relevant phases. The performance of physicochemical processes can be largely determined by how water interacts with itself (viscosity, surface tension) and with the constituents contained within it (hydration/solvation). These phenomena can be highly dependent on interfacial and solution properties at molecular and even atomic levels.

Theories concerning how magnetic fields may affect matter, such as water, are being intensively studied at both conventional Newtonian and novel quantum scales. One finding from these studies is that materials can experience changes in energy when they are exposed to a magnetic field, for example, when the field is strong (for example, B>0.1 Tesla (T)), which serves as the basis for nuclear magnetic resonance imaging (NMR).

When matter, or a material “system”, is moving in, or out, of a magnetic field(s), the Helmholtz free energy can change, and such changes in the Helmholtz free energy can be more specifically induced by alterations in “magnetic energy” including, for example, single-ion anisotropy (also called exchange energy), magnetostatic energy, magneto crystalline anisotropy, Zeeman energy, and/or external stress energy caused by magnetoelastic strain and magnetostriction energy (εₑₓ+εₘₛ+εₐ+ε_{Z}+εₛₜᵣₑₛₛ+εₘₛₜᵣ). Differences in the “magnetic energy” can reconstruct patterns of physiochemical properties of water molecules, ions, and their correlation, as well as subsequent upscaled “performance”, for example, variances in water transport across a permeable barrier (membrane).

While the upscaled “performance” can be induced by interrelated responses of the physiochemical properties of water and ions to the differences in the “magnetic energy”, the responses can be categorized. A mechanism for changes in water clustering in the presence of a magnetic field has been proposed. One for water-ion associations using Stroke's law:

$$\frac{ν}{E} = \frac{ze}{6 π η {r}_{i ( s )}} \qquad ( Equation 1 ( a ) )$$

$$U = \frac{( {z}_{1} e ) ( {z}_{2} e )}{ε ( {r}_{i ( s + )} + {r}_{i ( s - )} )} {r}^{2} \qquad ( Equation 1 ( b ) )$$

and the Born model:

$$d {G}_{s f e} = - ( {q}^{2} / 4 π {ε}_{0} {R}_{e f f} ) ( {ε}_{r} - 1 ) / 2 ε \qquad ( Equation 1 ( c ) )$$

Differing from how water-water and water-ion interactions are theoretically described, how a magnetic field can induce differences in a material's free energy is more complex. A highly simplified quantum mechanics model (n=g_{N}B₀/2p and g_{N}=2pm_{N}/hl) can provide the fundamental basis for how this can occur. Under a magnetic field (B₀), the magnetic energy (n; contributing to total free energy) is introduced, and how the material interacts with the magnetic field is born from rearrangement of the nucleus spin (I) and the magnetic moment (m_{N}) in response to the magnetic field.

### 2. Theoretical

Water molecules interact via, for example, dipole-dipole interactions (such as hydrogen bonds) and intermolecular interactions determine various fluid properties such as surface tension, boiling point, and viscosity. As described herein, properties of fluids and/or solutes therein, such as water molecule(s) and/or ions, can be altered by passage, or exposure, to a magnetic field resulting in changes in, for example, water's intermolecular interactions. Hydrogen bonds themselves may not be altered; however, due to changes in polar covalent bond properties of the water molecule(s), the prominence of hydrogen bonds in determining molecular behaviors may become more or less substantial.

A particle, such as an ion, molecule, particulate, or combinations thereof, among others, passing through a magnetic field can be exposed to energy. The magnitude and action of this energy can be a function of the particle properties, magnetic field(s) properties, and motion of the particle relative to the magnetic field(s). In Einstein's function, the general term of magnetic energy, U, has been estimated in earlier studies, and details pertaining to the computation of U are detailed elsewhere. Energy introduced into the water by the magnetic field, E(B), can be calculated according to Equation 2:

$$E ( B ) = - \frac{{S}_{0}^{2}}{2} {\sum }_{i j} {J}_{i j} - g {μ}_{B} B N S \qquad ( Equation 2 )$$

where B is the strength of the magnetic field (for example, about 1.35 T); S₀ is the uniform angular momentum, or spin, of the target through the magnetic device at constant temperature; Jᵢⱼ is the exchange coefficient for each target in the fluid (for example, fluid is water); g is the dimensionless magnetic moment of the target; μ_{B} is the permeability of the permanent magnet(s) (for example, permanent neodymium magnets); S is total momentum of substances moving through the magnetic field; and N is number of lattice sites of the target. The value of gμ_{B}BNS is a linear function of the flow velocity through the magnetic field.

Because the energy computed using Equation 2 is performed at the quantum mechanics scale and does not reveal the relationship between the energy and velocity, the relativistic relation between kinetic energy and momentum can be introduced to form Equation 3:

$$E = \sqrt{{p}^{2} {c}^{2} + {m}^{4} {c}^{4}} - m {c}^{2} \qquad ( Equation 3 )$$

Equation 3 can be expanded and expressed as a Taylor series approximation of Equation 4. Equation 4 shows how molecular mechanics may be combined with Newtonian mechanics when water molecules are considered collectively,

$$E \approx \frac{{p}^{2}}{2 m} - \frac{{p}^{4}}{8 {m}^{3} {c}^{2}} \qquad ( Equation 4 )$$

The energy of water molecules can be dependent on the structure of the molecule and may be changed when the temperature changes or by application of other external energy, and thus, when external energy is considered as another aspect

$$- \frac{{S}_{0}^{2}}{2} {\sum }_{i j} {J}_{i j}$$

of Equation 2, the internal energy

$$- \frac{{S}_{0}^{2}}{2} {\sum }_{i j} {J}_{i j}$$

can be considered as constant. And though the external energy, −gμ_{B}BNS part of Equation 2, provided by moving through the magnetic field is through changing angular momentum of a water molecule, it can be physio-mathematically renormalized as linear momentum.

Because the radius of rotation can be considered as going to infinity, which can be from molecule scale to Newtonian mechanics scale, and, thus, the angular momentum can be renormalized as linear momentum as shown in Equation 5:

$$L = m {R}^{2} ω = R m v \qquad ( Equation 5 )$$

wherein: L represents the linear momentum; m is the mass of all substances in the fluid (for example, water); R is radius of rotation of the target; and v is the velocity of the target.

Because Equation 3 and Equation 4 supports that potentiality, molecular mechanics could be correlated to Newtonian mechanics, the total angular momentum, S in Equation 2 is substituted with Rmv in Equation 5 to form Equation 6:

$$E ( B ) = - \frac{{S}_{0}^{2}}{2} {\sum }_{i j} {J}_{i j} - g {μ}_{B} BRNmv \qquad ( Equation 6 )$$

wherein: E(B) is the magnetic energy introduced by the magnetic field; S₀ is an uniform angular momentum, or spin, of the target through the magnetic device at constant temperature; Jᵢⱼ is an exchange coefficient for each target present in the fluid; g is a dimensionless magnetic moment of the target; Up is a permeability of the one or more permanent magnets; B is a strength of the magnetic field; N is a number of lattice sites of the target; R is radius of rotation of the target; m is a mass of all substances in the fluid; and v is a flow velocity of the target. The target can be, for example, water, a solute in the water (for example, a salt or ion thereof), or combinations thereof.

The energy introduced by the magnetic field, E(B), can increase linearly with flow velocity.

Building on these efforts (Equation 6), parameters accounting for, e.g., the dimensional characteristics of that system, can be introduced. The local magnetic field gradient can be further estimated from the referred models (Equation 7) in which the local magnetic field, dB, is embedded:

$$\int \frac{n {m}_{e f f}^{2} 4 η v BdB}{3 {k}_{B} T \frac{1}{4} {{μ}_{0} [ ( 2 {D}_{↑ , ↓} ) {ε}_{F} {μ}_{B}^{2} {μ}_{0} H ]}^{2} P} d x = U \qquad ( Equation 7 )$$

In Equation 7, n is the number of particles per unit volume (dimensionless); m_{eff} is the effective mass of the magnet (m²·V⁻¹·sec⁻¹); n is the magnetic mobility of relevant particle moving through the magnetic field; V is flow velocity (cm/sec); B is magnetic field strength (T); dB is the local magnetic field gradient (T); k_{B} is Boltzmann's constant; T is fluid temperature; μ₀ is the permeability of the magnetic field in a vacuum (1.256637×10⁻⁶ H/m); D_{↓,↑} is (spins) state density of the particle (dimensionless); ε_{F} is the Fermi energy (eV) which is calculated according to number of particles, unit volume, and invariant mass of fermion; μ_{B} is the Bohr magneton (9.274×10⁻²⁴ Am²); H is an applied local field; dx is the spatial location (x, y, and z) of the particle; U a general term of magnetic energy; and P is the pressure in the flow-through magnetic apparatus, which is a function of the flowrate and headloss through the system.

The local magnetic field gradient, dB, which is the difference in magnetic field per unit change at a direction in the Faraday balance, can be calculated according to Equation 8:

$$d B = d \{ \frac{j {μ}_{0}}{2} [ \frac{{L}^{4} + {r}^{4} + 2 {L}^{2} {r}^{2} - {r ( {L}^{2} + {r}^{2} )}^{\frac{3}{2}} + {L}^{2} r \sqrt{{L}^{2} + {r}^{2}}}{2 ( {L}^{4} r + 2 {L}^{2} {r}^{3} + {r}^{5} )} ] \} \qquad ( Equation 8 )$$

wherein: L is the length of the magnet; r is the radius of the magnet, and j is the current density of the used magnet(s), where j=J/μ₀. Equation 8 can be utilized for determining, for example, the size of the flow-through magnetic device and selection of the magnet(s). The parameter j can be utilized for field type selection.

When the magnets are cylindrical, the cylindrical geometry can be selected to simplify the computational requirements required for determining dB. When permanent magnets are used, no external electric current applied may be applied, though it is contemplated that external electric current can be applied. Therefore, the current density can be determined using the magnetic polarization, J, which is measured in units of Tesla (like B) and can be accessed through the magnetization and vacuum permeability of the magnets, μ₀, according to Maxwell's equations.

Any suitable magnet may be utilized. Characteristics of the magnet can be selected based on Equation 9 and Equation 10:

$${E}_{m s} = {\int }_{i} \frac{{m}_{e f f} {μ}_{0} B \cdot {H}_{d}}{2 d} {d}^{3} r \qquad ( Equation 9 )$$

wherein: Eₘₛ is the effective magnetic energy of given magnet (kJ); m_{eff} is the effective mass of the magnet (kg); B is magnetic field strength (Tesla); H_{d} is internal high field induced by the magnet; μ₀ is the permeability of the magnetic field in a vacuum (1.256637×10⁻⁶ H/m); r is the radius of the magnet (m); d is the density of the magnet (kg/m³). In Equation 9, the dot product (B·H_{d}) accounts for offset angle between magnets.

Two magnets (magnet “s” and magnet “b”) can be compared by Equation 10:

$${R}_{{E}_{m s - b} / {E}_{m s - s}} = \frac{{\int }_{i} \frac{{m}_{eff - b} {μ}_{0} B \cdot {H}_{d}}{2 {d}_{b}} {d}^{3} r}{{\int }_{i} \frac{{m}_{eff - s} {μ}_{0} B \cdot {H}_{d}}{2 {d}_{s}} {d}^{3} r} \qquad ( Equation 10 )$$

wherein: R is the ratio of the effective magnetic energy values (E_{ms-b}/Eₘₛ₋ₛ) for two magnets.

Changes in molecular properties can be evaluated in terms of parameters related to applied hydrodynamic conditions and the total Gibbs free energy induced by movements within the multi-directional magnetic fields. The Gibbs free energy of the O—H bond, the C—H bond, Ca²⁺—H₂O, and Mg²⁺—H₂O is 4.76 eV, 4.26 eV, 16.50 eV, and 18.97 eV, respectively. Referring back to Equation 7, Equation 7 can be utilized to determine at what flow velocity the bond energy of O—H, or any other known suitable bond, is exceeded. In some embodiments, a bond energy of O—H is exceeded at a flow velocity of about 10 cm/sec or more through a magnetic field (wherein n, which is the number of magnetic fields in series, is about 20 or more).

Changes in, for example, O—H bond length and/or H—O—H bond angle in response to energy added can be determined by, for example, molecular dynamics simulations with pairwise-additive force fields that account for the bonds' electromagnetic properties. In some embodiments, molecular dynamics simulations can be performed to determine an operational magnetic energy that the target (for example, water and/or solute therein) can be subjected to, where the operational magnetic energy is an output of apparatus described herein. For example, the molecular dynamics simulations can utilize U, and/or net energy as inputs for the molecular dynamics simulations. Here, U is the magnetic energy experienced by the target (for example, water and/or solute therein) and determined according to Equation 7. A chemical bond (for example, O—H, Ca²⁺—H₂O, Na⁺—H₂O, and/or Mg²⁺—H₂O) that would be altered or transformed can be determined based on the value of U. The target (water and/or solute therein) can then be exposed to an operational magnetic energy that is greater than a bond energy of at least one chemical bond present in the water and/or solute therein, causing the alteration or transformation of the chemical bond. This alteration or transformation causes a property of the water and/or solute therein to be changed. The operational magnetic energy is produced by, for example, flow-through magnetic field devices described below.

Such properties of the target (for example, water and/or solute therein such as a salt, ion thereof, or combinations thereof) that can be altered by using apparatus described herein (for example, an operational magnetic field) can include, molecular properties and/or mesoscale properties.

Molecular properties of the target can include, but are not limited to, a bond energy, a bond angle, a spin state, an energy state, a polarizability, a hydration shell, or combinations thereof.

Mesoscale properties of the target can include, but are not limited to, a dynamic viscosity, a permeance through a selective membrane, a flux, a surface tension, a density, a vapor pressure, hydrogen bonding, a viscosity, a permeability, a solubility, a polarity, a pH, a conductivity, a reactivity, a thermal conductivity, an enthalpy, an entropy, a boiling point, a vapor point, or combinations thereof.

In some examples, the operational magnetic field produced by apparatus described herein can be utilized to dehydrate an ion (for example, sodium and/or chloride), change (for example, enhance) water clustering/water structuring, change (for example, increase) O—H bond length, change (for example, decrease) H—O—H bond angle, combinations thereof, among other applications.

### 3. Non-Limiting Apparatus, Materials, and Methods

### 3.1. Example Apparatus

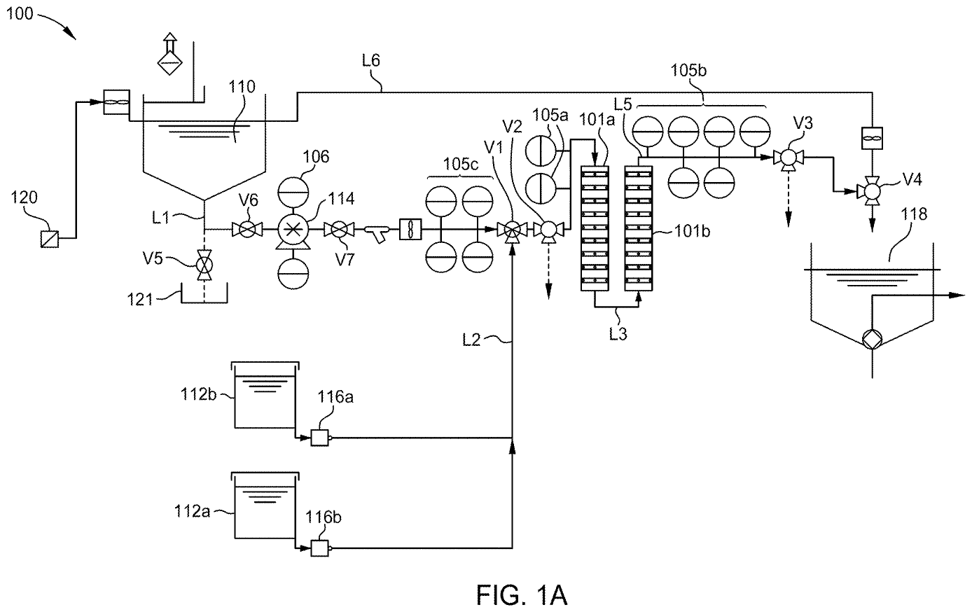

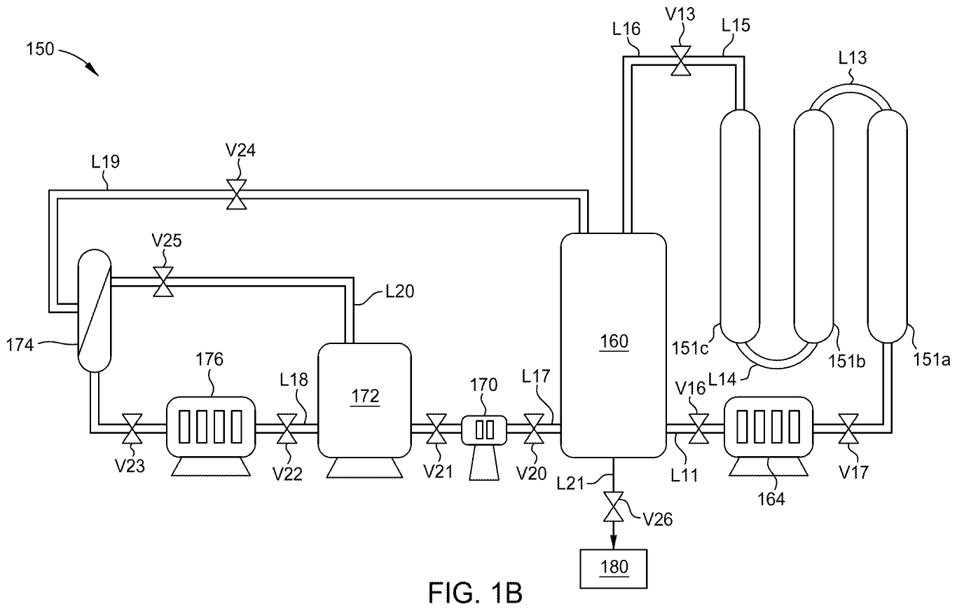

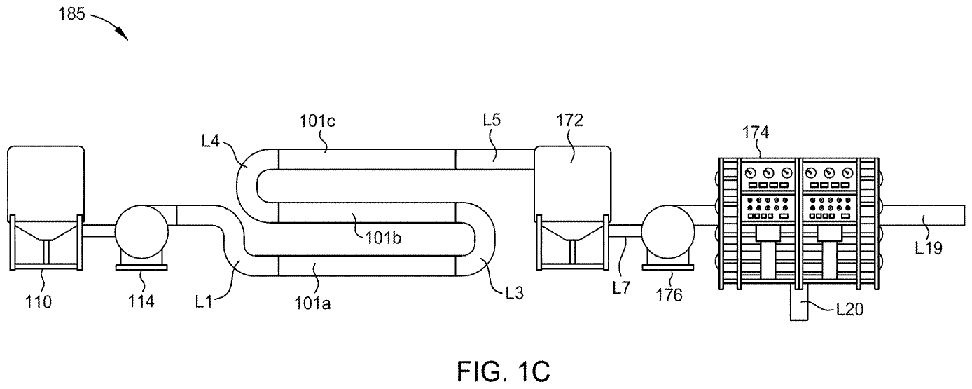

A non-limiting process flow diagram for a flow-through magnetic apparatus 100 is shown in FIG. 1A. The flow-through magnetic apparatus 100 can be used for magnetically treating a feed for desalination.

The flow-through magnetic apparatus 100 can include one or more flow-through magnetic field devices 101a and 101b. Each of the flow-through magnetic field devices 101a and 101b can include any suitable magnet(s) housed in any suitable container(s), for example, permanent neodymium magnets (for example, B=about 1.35 T, N45 Grade NdFeB) housed in stainless steel containers. The flow-through magnetic field devices 101a and 101b can be referred to as pipes, tubes, channels, or fluid passages. The stainless steel containers can serve to protect the magnet from abrasion and protection from the liquid environment. In the absence of this protection the magnets can become damaged and lose their magnetic flux density. The flow-through magnetic field devices 101a and 101b are coupled via line L3. Effluent can exit the flow-through magnetic field devices 101a and 101b via line L5 coupled to a drain 118.

Each of the flow-through magnetic field devices 101a and 101b includes a first end (influent side), a second end (effluent side), and a flow path coupling or connecting the first end with the second end. Fluid comprising water or other aqueous fluid flows through the flow path. The fluid can include water, salts, ions thereof, or combinations thereof. The first end can include one or more inlets and the second end can include one or more outlets. The inlets and outlets can be adapted to receive the same fluid or different fluid. A fluid can be introduced through the first end and enter the flow path, and exit the second end of each of the flow-through magnetic field devices 101a and 101b.

In some examples, a first inlet of the one or more inlets can be adapted to receive a “fresh” fluid. Fresh fluid refers to a fluid that has not been exposed to magnetic energy (magnetic field) emitted by a flow-through magnetic field device described herein.

In at least one example, a second inlet of the one or more inlets can be adapted to receive a “recirculated” fluid. Recirculated fluid refers to a fluid that has been exposed to magnetic energy (magnetic field) emitted by a flow-through magnetic field device described herein.

Additionally, or alternatively, a single inlet can be adapted to receive a fresh fluid, a recirculated fluid, or combinations thereof. That is, apparatus of the present disclosure can be utilized for treating a fluid one or more times.

In some implementations, each of the flow-through magnetic field devices 101a and 101b includes, independently, a single magnet or an array of magnets. The array of magnets can have varied orientation. While the discussion and data of the present disclosure pertains to single pass operations, scale-up designs and implementations can be advantaged by recirculation.

Each of the flow-through magnetic field devices 101a and 101b can include any suitable number of magnets (for example, about 72 magnets) with any suitable centerline spacing such as a centerline spacing of about 6.8 cm. The stainless steel containers can be offset from one another forming a double helix shape through the flow-through magnetic field devices 101a and 101b to generate a multidirectional magnetic field. The helical arrangement of the magnets can create a multi-directional magnetic field configuration, which can prevent the particles from moving in only one direction from which unidirectional effects would stem. This non-limiting design can result in non-unidirectional consistent spin alterations for the aqueous fluid, which can maximize the energy that is gained by the aqueous fluid from the magnetic fields. Unidirectional magnetic fields can result in a singular directional magnetic field gradient, which can reduce the magnetic energy experienced by a given particle.

The flow-through magnetic apparatus 100 can include a feed reservoir 110 that contains feed to be flowed through the flow-through magnetic field devices 101a and 101b. The feed reservoir can be coupled to a feed source 120 that contains the feed for magnetic treatment. The feed reservoir is coupled to the first end (influent side) of the flow-through magnetic field device 101a. The feed can be drawn from the feed reservoir 110 by a pump 114 positioned along line L1. The pump 114 can include sensors 106 for monitoring, for example, pressure, energy, and/or other parameters. A valve (such as three-way valve V1) can couple the feed reservoir to the rest of the flow-through magnetic apparatus 100. If desired, the flow-through magnetic apparatus 100 can include one or more reservoirs 112a, 112b. The reservoirs 112a, 112b can contain chemicals (for example, a dechlorinating agent) that can be added to the feed. The reservoirs 112a, 112b can be coupled to the three-way valve V1 via a pump 116a, 116b and a line L2. Three-way valves V2 and V3 can be used to collect influent sample and effluent sample, respectively, for investigation.

The flow-through magnetic apparatus 100 can include one or more inline sensors (for example, three inline sensors 105a, 105b, 105c are shown). Inline sensors 105a and 105c are located along line L1. Inline sensor 105b is located along line L5. Although two inline sensors 105a, six inline sensors 105b, and four inline sensors 105c are shown, any suitable number of inline sensors can be utilized. The inline sensors can be utilized for measuring various parameters such as flow rate, temperature, pH, electrical conductivity, dissolved oxygen concentration, or combinations thereof in the influent to, and effluent from, the containers containing the magnets.

The flow-through magnetic apparatus 100 can include a drain 118 coupled to the second end of the flow-through magnetic field device 101b by a line L5. The drain 118 is used to collect at least a portion of effluent exiting the flow-through magnetic field devices 101a and 101b. That is, the drain 118 collects the treated feed (magnetically treated feed) that can then be fed to a desalination system (for example, a reverse osmosis system). The flow-through magnetic apparatus 100 can further include a line L6 coupled to three-way valve V4 in which effluent exiting the flow-through magnetic field devices 101a and 101b can be recycled or recirculated back through the flow-through magnetic apparatus 100. This effluent that is recycled or recirculated is a recirculated fluid.

When at least a portion of the feed is not fed to a desalination apparatus via the drain 118, the feed can be fed via line L6 to feed reservoir 110 to be drained via two-way valve V5 to drain 121, and/or the feed can be fed back through the flow-through magnetic apparatus 100 via two-way valve V6, two-way valve V7, and three-way valve V1.

Although not shown, one or more valves can be positioned along lines L3 and L4 for collecting sample such that influent and effluent flows from each of the two flow-through magnetic field devices 101a and 101b. Valve V2 can be used to sample the influent entering the flow-through magnetic field device 101a and valve V3 can be used to sample the effluent exiting the flow-through magnetic field device 101b.

The flow-through magnetic apparatus 100 can include a selective membrane (not shown in FIG. 1A). The selective membrane can be coupled, directly or indirectly, to a second end of a flow-through magnetic field device. Useful membranes can include reverse-osmosis (RO) membranes, nanofiltration membranes, forward osmosis membranes, or combinations thereof, among others.

FIG. 1B shows a non-limiting process flow diagram of a membrane-magnetic field apparatus 150 according to at least one embodiment of the present disclosure. Here, the membrane-magnetic field apparatus 150 includes a desalination apparatus (for example, a membrane) integrated with a flow-through magnetic apparatus. As shown in FIG. 1B, the flow-through magnetic apparatus is integrated with the desalination apparatus via a connector pump 170. The flow-through magnetic apparatus can be used for magnetically treating a feed that is then used for desalination.

The membrane-magnetic field apparatus 150 includes one or more flow-through magnetic field devices, and in this example, three flow-through magnetic field devices 151a-151c are shown. Each of the flow-through magnetic field devices 151a-151c can include any suitable magnet(s) housed in any suitable container(s), for example, permanent neodymium magnets (for example, B=about 1.35 T, N45 Grade NdFeB) housed in stainless steel containers. The flow-through magnetic field devices 151a-151c can be referred to as pipes, tubes, channels, or fluid passages. The stainless steel containers can serve to protect the magnet from abrasion and protection from the liquid environment. In the absence of this protection, the magnets can become damaged and lose their magnetic flux density. The flow-through magnetic field devices 151a-151c are coupled to one another via line L13, and line L14.

Each of the flow-through magnetic field devices 151a-151c includes a first end (influent side), a second end (effluent side), and a flow path coupling or connecting the first end with the second end. Fluid comprising water or other aqueous fluid flows through the flow path. The fluid can include water, salts, ions thereof, or combinations thereof. The first end can include one or more inlets and the second end can include one or more outlets. The inlets and outlets can be adapted to receive the same fluid or different fluid. A fluid can be introduced through the first end and enter the flow path, and exit the second end of the flow-through magnetic field devices 151a-151c.

In some examples, a first inlet of the one or more inlets can be adapted to receive a fresh fluid. In at least one example, a second inlet of the one or more inlets can be adapted to receive a recirculated fluid. Additionally, or alternatively, a single inlet can be adapted to receive a fresh fluid, a recirculated fluid, or combinations thereof. That is, apparatus of the present disclosure can be utilized for treating a fluid one or more times.

In some implementations, each of the flow-through magnetic field devices 151a-151c includes, independently, a single magnet or an array of magnets. The array of magnets can have varied orientation. While the discussion and data of the present disclosure pertains to single pass operations, scale-up designs and implementations can be advantaged by recirculation.

In some examples, each of the flow-through magnetic field devices 151a-151c can include any suitable number of magnets (for example, about 72 magnets) with any suitable centerline spacing such as a centerline spacing of about 6.8 cm. The stainless steel containers can be offset from one another forming a double helix shape through the flow-through magnetic field devices 151a-151c to generate a multidirectional magnetic field. The helical arrangement of the magnets can create a multi-directional magnetic field configuration, which can prevent the particles from moving in only one direction from which unidirectional effects would stem.

The apparatus 150 can further include a feed reservoir 160 that contains feed to be flowed through the flow-through magnetic field devices 151a-151c. The feed reservoir 160 can be coupled to a feed source (not shown) that contains the feed for magnetic treatment. The feed reservoir is coupled to the first end (influent side) of the flow-through magnetic field device 151a. The feed reservoir 160 is further coupled to collection unit 180 which collects a desalinated fluid. The feed reservoir is further coupled to pump 164 and valve V16 positioned along line L11. Pump 164 is coupled to the flow-through magnetic field devices 151a-151c via valve V17.

The feed for magnetic treatment can be drawn from the feed reservoir 160 by the pump 164. The pump 164 can include sensors for monitoring, for example, pressure, energy, and/or other parameters as described above in connection to pump 114. If desired, the apparatus 150 can include one or more reservoirs to add chemicals (for example, a dechlorinating agent) to the feed as described above with respect to reservoirs 112a, 112b. The feed reservoir 160 can also be used to collect the magnetically treated feed, i.e., fluid that has passed through the flow-through magnetic field devices 151a-151c.

The apparatus 150 can further include one or more inline sensors (not shown) for monitoring measuring various parameters such as flow rate, temperature, pH, electrical conductivity, dissolved oxygen concentration, or combinations thereof in the influent to, and effluent from, the containers containing the magnets. Such inline sensors are described herein with respect to the flow-through magnetic apparatus 100.

Fluid exiting the flow-through magnetic field devices 151a-151c can exit via line L15 through valve V13 and line L16 and fed back to feed reservoir 160. The fluid fed back to the feed reservoir 160 can then be fed to desalination (via connector pump 170), or recirculated back through the flow-through magnetic field devices 151a-151c via pump 164, or collected in a collection unit 180 via line L21.

Feed reservoir 160 is coupled to the connector pump 170 via valve V20 and line L17. The connector pump 170 can include sensors for monitoring, for example, pressure, energy, and/or other parameters. The connector pump 170 is coupled to a desalination feed tank 172 (for example, a reverse osmosis feed tank) via valve V21. The desalination feed tank 172 is coupled to a desalination membrane 174 (for example, a reverse osmosis membrane) serving to desalinate the magnetically treated fluid. Effluent exiting the desalination feed tank 172 through line L18 can be fed to the desalination membrane 174 by using a desalination pump 176. The desalination pump 176 is coupled to the desalination feed tank 172 via a valve V22 and is coupled to the desalination membrane 174 via valve V23.

At the desalination membrane 174, the magnetically treated fluid is desalinated. A first effluent (permeate) that is desalinated as desired can exit the desalination membrane 174 via line L19 and valve V24 and fed to the feed reservoir 160. This desalinated fluid can be fed to the flow-through magnetic field devices 151a, 151b, and 151c. Additionally, or alternatively, the desalinated fluid can exit the feed reservoir 160 via line L21 and valve V26 and collected at the collection unit 180.

A second effluent (reject) can be fed back to the desalination feed tank 172 via line L20 and valve V25. The reject can be mixed with magnetically treated fluid in the desalination feed tank 172 and fed back to the desalination membrane 174. Additionally, or alternatively, the second effluent can be removed from the apparatus 150 by a valve (not shown).

FIG. 1C shows a non-limiting process flow diagram of a membrane-magnetic field apparatus 185 according to at least one embodiment of the present disclosure. Here, the membrane-magnetic field apparatus 185 includes a desalination element (for example, a membrane) integrated with a flow-through magnetic apparatus. As shown in FIG. 1C, the flow-through magnetic apparatus is integrated with the desalination element via a desalination pump 176. The flow-through magnetic apparatus can be used for magnetically treating a feed that is then used for desalination.

The membrane-magnetic field apparatus 185 can include one or more flow-through magnetic field devices, and in this example, three flow-through magnetic field devices 101a-101c. Each of the flow-through magnetic field devices 101a-101c can include any suitable magnet(s) housed in any suitable container(s), for example, permanent neodymium magnets (for example, B=about 1.35 T, N45 Grade NdFeB) housed in stainless steel containers. The flow-through magnetic field devices 101a-101c can be referred to as pipes, tubes, channels, or fluid passages. The stainless steel containers can serve to protect the magnet from abrasion and protection from the liquid environment. In the absence of this protection the magnets can become damaged and lose their magnetic flux density.

Each of the flow-through magnetic field devices 101a-101c includes a first end (influent side), a second end (effluent side), and a flow path coupling or connecting the first end with the second end. Fluid comprising water or other aqueous fluid flows through the flow path. The first end can include one or more inlets and the second end can include one or more outlets. The inlets and outlets can be adapted to receive the same fluid or different fluid. A fluid can be introduced through the first end and enter the flow path, and exit the second end of the flow-through magnetic field devices 101a-101c.

In some examples, a first inlet of the one or more inlets can be adapted to receive a fresh fluid. In at least one example, a second inlet of the one or more inlets can be adapted to receive a recirculated fluid. Additionally, or alternatively, a single inlet can be adapted to receive a fresh fluid, a recirculated fluid, or combinations thereof. That is, apparatus of the present disclosure can be utilized for treating a fluid one or more times.

In some implementations, each of the flow-through magnetic field devices 101a-101c includes, independently, a single magnet or an array of magnets. The array of magnets can have varied orientation. While the discussion and data of the present disclosure pertains to single pass operations, scale-up designs and implementations can be advantaged by recirculation.

Each of the flow-through magnetic field devices 101a-101c can include about 72 magnets with any suitable centerline spacing such as a centerline spacing of about 6.8 cm. The stainless steel containers can be offset from one another forming a double helix shape through the flow-through magnetic field devices 101a-101c to generate a multidirectional magnetic field. The helical arrangement of the magnets can create a multi-directional magnetic field configuration, which can prevent the particles from moving in only one direction from which unidirectional effects would stem. This non-limiting design can result in non-unidirectional consistent spin alterations for the aqueous fluid, which can maximize the energy that is gained by the aqueous fluid from the magnetic fields.

The apparatus 185 can include a feed reservoir 110 coupled to the flow-through magnetic field devices 101a-101c. The feed reservoir 110 contains feed for magnetic treatment. The feed can be drawn from feed reservoir 110 by a pump 114 positioned along line L1. The flow-through magnetic field devices 101a-101c are coupled by lines L3 and L4, such that effluent from flow-through magnetic field device 101a is fed by line L3 to flow-through magnetic field device 101b, and effluent from flow-through magnetic field device 101b is fed by line L4 to flow-through magnetic field device 101c. The apparatus 185 can optionally include one or more inline sensors and one or more valves for, e.g., sampling, as described herein.

The apparatus 185 can further include a desalination feed tank 172 (for example, a reverse osmosis feed tank) coupled to the flow-through magnetic field device 101c via line L5. The desalination feed tank 172 is coupled to a desalination membrane 174 (for example, a reverse osmosis membrane) serving to desalinate the magnetically treated fluid. Effluent exiting the desalination feed tank 172 through line L7 can be fed to the desalination membrane 174 by using a desalination pump 176 positioned along line L7. At the desalination membrane 174, the magnetically treated fluid is desalinated. A first effluent (permeate) that is desalinated as desired can exit the desalination membrane 174 via line L19. A second effluent (reject) can exit the desalination membrane 174 via line L20. If desired, magnetically treated fluid can be recycled or recirculated back through the flow-through magnetic field devices 101a-101c as described above.

Embodiments and implementations of each of FIGS. 1A, 1B, and/or 1C can be combined with one another in any suitable fashion.

Various operational parameters of the apparatus can be selected, such as a magnetic field strength, a fluid flow velocity through the magnetic field, or combinations thereof. The fluid can be exposed to any suitable magnetic field strength while passing through the apparatus, such as about 0.1 Tesla (T) or more, 10 T or less, or combinations thereof, such as from about 0.1 T to about 10 T, such as from about 0.5 T to about 5 T, such as from about 1 T to about 3 T, such as from about 1.1 T to about 1.5 T, though other values are contemplated. Any of the foregoing numbers can be used singly to describe an open-ended range or in combination to describe a close-ended range.

The fluid flow velocity through the magnetic field can be any suitable flow velocity, such as about 1 cm/sec or more, about 250 cm/sec or less, or combinations thereof, such as from about 5 cm/sec to about 200 cm/sec, such as from about 25 cm/sec to about 150 cm/sec, such as from about 50 cm/sec to about 100 cm/sec, or from about 5 cm sec to about 50 cm/sec, such as from about 7.8 cm/sec to about 46.7 cm/sec, such as from about 19.5 cm/sec to about 35.0 cm/sec, though other values are contemplated. Any of the foregoing numbers can be used singly to describe an open-ended range or in combination to describe a close-ended range.

### 3.2. Example Computational Model

Computations for a model system were performed using the following constraints: nanoconfinement (internal diameter of 1 nm, and length of 3 nm); media (water molecules, TIP4P model); potential (O—C atoms; Lennard Jones); magnetic field (multidirectional, B=0.6 T); temperature (T=298.15 K); control (no magnetic field). Based on the computations, exposure of the media to the magnetic field led to increased water transport across the nanoconfinement.

### 3.3. Example Membrane Performance Assessment

Any suitable membrane can be used. For the examples described herein, RO membranes such as SW30HR (available from Dupont), ACM1, ACM2, and ACM5 (available from TriSep) membranes were utilized in associated performance tests. The SW30HR membrane has a reported sodium chloride rejection of ≥99%. The SW30HR membrane includes an active layer, microporous support, and backing of made from polyamide, polysulfone, and polyethylene, respectively. The measured contact angle with water for the SW30HR membrane was determined to be about 66±3.7°. The permeance of the SW30HR membrane was determined to be about 0.46±0.06 LMH/bar. The measured isoelectric point (pHᵢₑₚ) for the SW30HR membrane was determined to be about 4.47±0.06 using 1 mM potassium chloride solution as the background electrolyte.

The ACM1 membrane is a polyamide thin-film composite membrane with a rejection value of about 99.5%, the ACM2 membrane is a polyamide thin-film composite membrane with an average NaCl rejection value of about 98.5%. The ACM5 membrane is characterized as a low-energy desalination membrane having a stabilized NaCl rejection of ≥98.5%.

Free chlorine concentration in the influent, after addition of the dechlorinating agent, can be monitored using the following models: pH (DPD1P1), conductivity (3700 Digital Inductive Conductivity Sensor), dissolved oxygen (LDO® Model 2), and free chlorine (CL 17).

Tests were performed using a membrane-magnetic field apparatus similar to that membrane-magnetic field apparatus 150 shown in FIG. 1C. Tests can be performed using a commercial seawater RO membrane (SW30HR, Dow Filmtec). Permeance measurements were carried out using a crossflow test apparatus that incorporated a SEPA cell (Sterlitech Corporation) having an active area of 140 cm². Membrane samples were hydrated for about 24 hours or more in ultrapure water prior to performance testing. Membrane samples were compressed at a feed pressure of about 27.6 bar (about 400 psi) using ultrapure water until a steady-state flux was achieved. The permeation rate was measured using a computer interfaced flowmeter (ALICAT Scientific). The flowmeter output was periodically checked using manual measurements via water mass measurements over select time intervals. The feed solution was then be switched out for the relevant test solution. Solution temperature and pH for all tests was held constant at about 20° C. and about 7.0±0.1, respectively, unless indicated otherwise.

The flow-through magnetic apparatus used for the experiments included three flow-through pipes (that can be connected in series). The flow-through pipes can correspond to flow-through magnetic field devices 101a-101c described above. Each flow-through pipe contained neodymium magnets (B≈1.35 T, N45 Grade neodymium iron boron (NdFeB)) that were sealed in machined stainless-steel tubes arranged in a helical pattern through a length of the pipe having a total length of about 484 cm. Suitable N45 grade NdFeB magnets can have one or more of the following properties: induced magnetic flux, B, of about 1.35 T; applied magnetic field of about 955 kA/m; maximum energy produced (BHₘₐₓ) of about 350 KJ/ml and an electrical conductivity of about 667 kS/m. Other types of magnets (including materials and properties) are contemplated. Structures other than pipes are contemplated. Other suitable dimensions are contemplated.

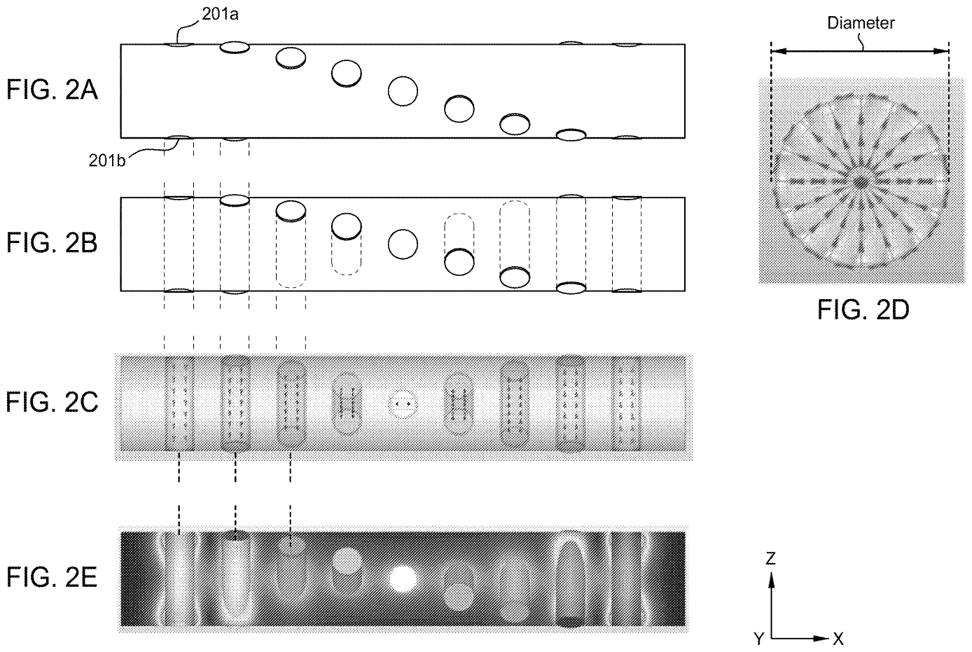

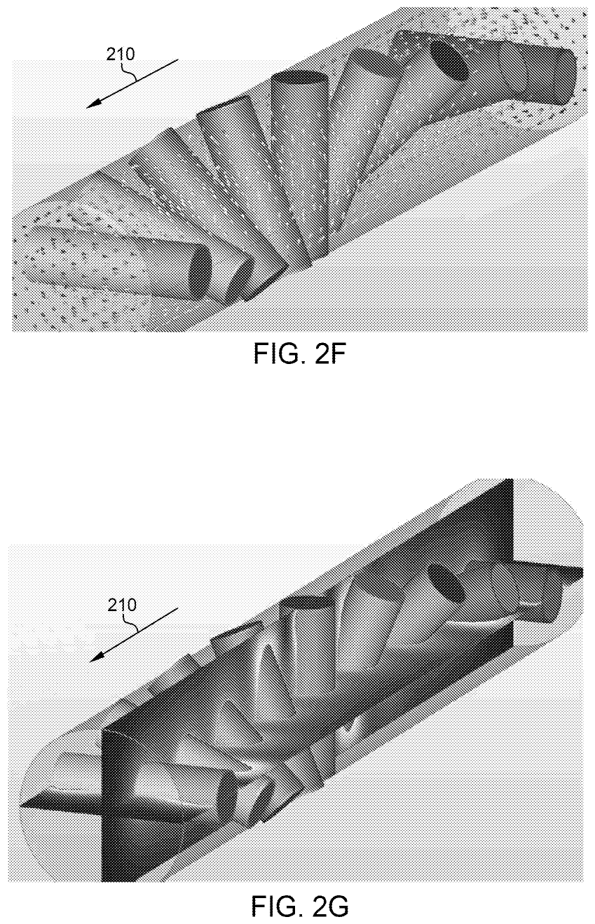

FIGS. 2A-2D show various views of a section of a flow-through magnetic field device (for example, a flow-through magnetic field device 101a or flow-through magnetic field device 151a) according to at least one embodiment of the present disclosure. Specifically, FIG. 2A shows an outer view, FIG. 2B shows an inner view, FIG. 2C shows another inner view, and FIG. 2D shows a diameter of a flow-through magnetic field device. The diameter of the flow-through magnetic field device can be any suitable diameter, such as from about 10 cm to about 11 cm, such as about 10.16 cm, though other diameters are contemplated. Of note, FIG. 2A shows the surface of the flow-through magnetic field device indicating non-limiting positions of magnets 201 in a helical arrangement, with one magnet 201a across from another magnet 201b. In this non-limiting design, the magnets are paired (for example, 201a and 201b) on either side of the flow-through magnetic field device. The inner view in FIGS. 2B-2E are not indicating that the magnets extend through the flow-through magnetic field device. Instead, it is showing different views of the magnetic energy density or magnetic field flux density.

FIG. 2E shows an illustration of the magnetic field flux density created by a section of a flow-through magnetic field device (for example, a flow-through magnetic field device 101a or flow-through magnetic field device 151a) according to at least one embodiment of the present disclosure. As shown, the flux density can change at various portions of the flow-through magnetic field device. FIGS. 2F and 2G show changes in magnetic field direction and changes in magnetic field flux density, respectively, created by a flow-through magnetic field device (for example, a flow-through magnetic field device 101a or flow-through magnetic field device 151a). The arrow 210 shows the direction of fluid (for example, water) flow through the flow-through magnetic field device. As in FIGS. 2B-2E, FIGS. 2F and 2G show are not indicating that the magnets extend through the flow-through magnetic field device. Instead, FIG. 2F shows the changes in magnetic field direction in different portions of the flow-through magnetic field device and FIG. 2G shows the changes in magnetic field flux density in different portions of the flow-through magnetic field device.

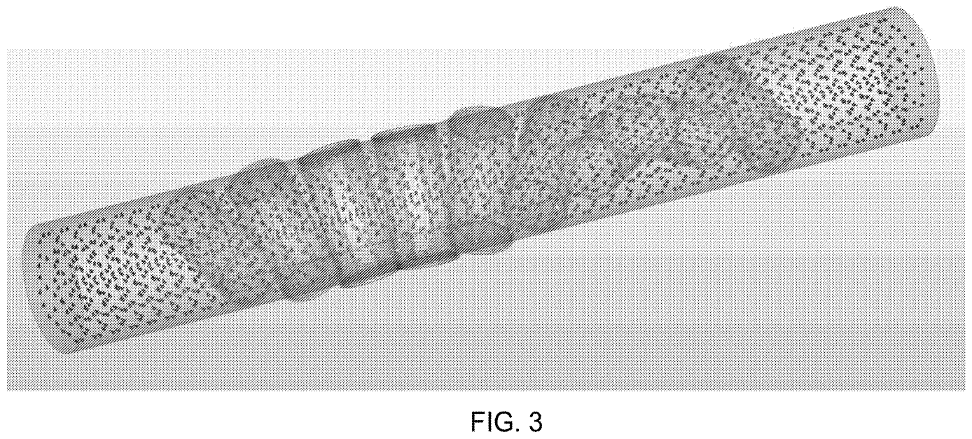

A non-limiting illustration of the magnetic field created in a section/portion of the pipe (for example, a section/portion of flow-through magnetic field device 101a or a section/portion of flow-through magnetic field device 151a), representing one complete cycle of the magnetic field arrangement, is shown in FIG. 3. The figure illustrates a section/portion of the multidirectional magnetic field highlighting the magnetic flux (B) and direction of the magnetic fields. The direction of the magnetic field at each point is shown by the direction of the arrow. The flux changes throughout the pipe, and may be concentrated within the “cylinders” shown in FIG. 3.

The shown model was developed using a finite element modeling program (Amperes V10.2). Other models and modeling programs are contemplated. The flow velocity through the magnetic field can be controlled using, for example, a variable frequency drive on the feed pump. As with FIGS. 2B-2G, the figure is not indicating that the magnets extend through the flow-through magnetic field device.

### 3.4. Example Water Quality Assessments

Dynamic viscosity of water was measured for samples prior to and after flowing through the multidirectional magnetic field. Measurements were performed utilizing a kinematic viscometer (SVM 3001; Anton Paar, Austria). All measurements were performed at a water temperature of 25° C. that was maintained by the instrument. The time between collecting the samples and subjecting the samples to viscosity measurement was ≤1 hour. Ultrapure water samples (μ=0.8900 mPa·sec at 25° C.) were incorporated into all sample matrices to serve as controls. Water pH and electrical conductivity were measure pre- and post the magnetic field using inline sensors (commercially available from Hach) that were interfaced with a data acquisition program.

### 4. Non-Limiting Results and Discussion

### 4.1. Alterations in Water Permeance

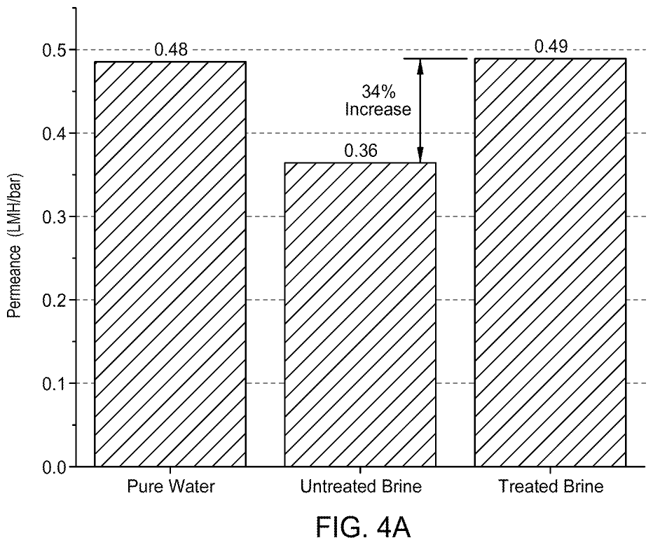

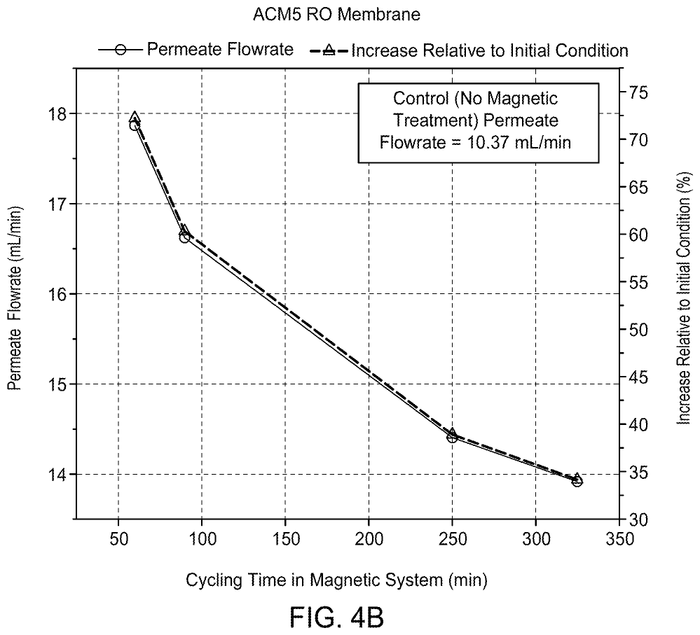

FIG. 4A shows non-limiting data comparing mean permeance values measured for a TriSep 1812 Sanitary Element, ACM1 reverse osmosis (RO) membrane in a spiral wound configuration. Mean values were determined for ultrapure (pure) water, a brine that was not pretreated using a flow-through magnetic apparatus, and a brine that had passed through (treated) the flow-through magnetic apparatus. The brine had a total dissolved solids (TDS) concentration of about 2,000 mg/L and a pH of about 7. Mean values were calculated for a period of about 24 hrs. The TriSep 1812 ACM1 membrane is a commercially available high-rejection (NaCl Rejection≥99.5%) desalination membrane.

The results shown in FIG. 4A indicate that permeance of the fluid through a desalination membrane significantly increases from about 0.36 LMH/bar (liters per square meter hour/bar) to about 0.49 LMH/bar, representing an increase in permeance of about 34%. Overall, the data indicates that embodiments described herein can be used to alter properties of a fluid and increase the permeance of the fluid through membranes.

FIG. 4B shows non-limiting permeate flowrate data for an ACM5 RO membrane treating ultrapure water that was recycled through a flow-through magnetic apparatus. The ACM5 membrane is a commercially available RO membrane characterized as a low-energy desalination membrane having a stabilized NaCl rejection of ≥98.5%. Prior to commencement of the test, the flat-sheet membrane samples, operated in a crossflow configuration, were compressed at a feed pressure of about 225 psi for about 24 hours so that the water flux achieved a steady-state value. The feed solution was switched to magnetically treated water at the end of the compression period. In FIG. 4B, initial condition refers to ultrapure water that had not passed through the flow-through magnetic apparatus.

The results shown in FIG. 4B indicate that the flow rate (flux) through the membrane remained greater for those that passed through the flow-through magnetic apparatus than that which was measured using ultrapure water that had not passed through the flow-through magnetic apparatus. It was noted that, under the conditions tested, the flow rate (flux) through the membrane decreased with increasing cycling time within the flow-through magnetic apparatus. Overall, the data indicates that embodiments described herein can be used to alter properties of a fluid and increase the flow rate of the fluid through membranes.

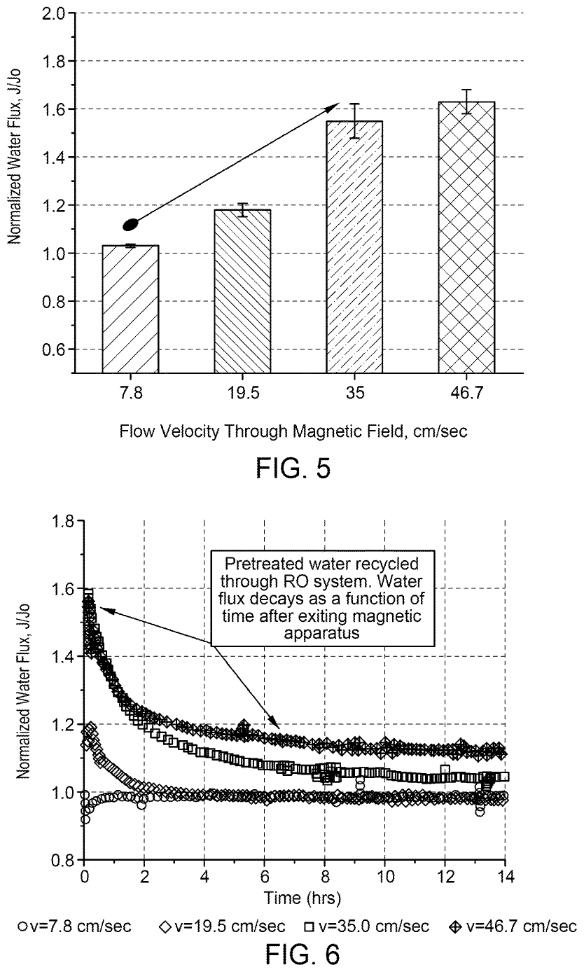

FIG. 5 shows normalized water flux values using the SW30HR membrane for water that had passed through the flow-through magnetic apparatus at different flow velocities. The flux was normalized to the steady-state water flux measured for the non-magnetized water. For the data shown in FIG. 5, the SW30HR membrane (water permeance of about 0.46±0.06 LMH/bar; contact angle of about 66±3.7°; sodium chloride rejection≥99%) was used. The experiment included the following operating parameters: temperature of about 20° C., a pressure of about 27.51 bar, and a pH of about 7.68. The normalized water flux values represent the mean values over the first hour after having passed through the magnetic field. The arrow in FIG. 5 indicates the increasing water permeability through the RO membrane.

As the relevant process conditions of feed pressure, temperature, and solution pH are held constant across all tests, the data shown in FIG. 5 indicated that the water permeance (LMH/bar) across the membrane can be increased by first passing the feed solution through the flow-through magnetic apparatus. This increase in permeance translates into a reduction in pumping pressure (energy) required to achieve a given water flux (LMH) set-point. This increase in permeance can be a combined function of a reduction in the dynamic viscosity (Pa*sec) of water and possibly temporary changes in the characteristics of the polar covalent bonds between the oxygen and two protons that make up a water molecule. Further, changes in the covalent bonds can influence the structuring/clustering characteristics, and thus transport, of water molecules within the free volume space that comprises the polyamide skin layer on the salt rejecting membrane. Overall, the data in FIG. 5 indicates that embodiments described herein can be used to alter properties of a fluid, such as the fluid's flux across a non-porous membrane.

FIG. 6 shows normalized (water flux at a given time, J, divided by the initial steady state water flux, J₀) water flux as a function of time using the SW30HR membrane for water that had passed through the flow-through magnetic apparatus. Membranes were evaluated in a flat-sheet cross-flow configuration. Membrane samples were compressed at a feed pressure of 400 psi using ultrapure water (pH=7) for 24 hours or until a steady-state water flux was reached. At time=0 hours, the ultrapure feed solution was then switched to ultrapure water that had been passed through the flow-through magnetic apparatus. Four different flow velocities (v)—about 7.8 cm/sec, about 19.5 cm/sec, about 35.0 cm/sec, and about 46.7 cm/sec—through the flow-through magnetic apparatus were evaluated. Each evaluation was performed with a new set of RO membrane samples. The decay in water flux with recycling time in the RO membrane, or time after the feed solution exited the flow-through magnetic apparatus, corresponds to the relaxation period in the elevated energy state of the water molecules after exiting the flow-through magnetic apparatus.

As shown in FIG. 6, the water flux is higher than the control (water that has not passed through a flow-through magnetic apparatus) at time 0 hours. After a certain period, the water flux decreases over time, returning to approximately the flux measured in the absence of the magnetic field, after having passed through the magnetic field. The increase in water flux can correlate with flow velocity through the magnetic field(s) as flow velocity determines the magnitude of the magnetic energy experienced by the water molecule and the corresponding changes in molecular structure. This result suggested that the energy introduced into the aqueous media can be a function of the velocity through the magnetic field.

In addition, and under the conditions tested, the observed changes in water properties and behaviors (transport through the membrane) were determined to be impermanent and returned to an original state after a period of several hours. This phenomenon is termed as a memory effect. While not wishing to be bound by any theory, this memory effect may be attributed to the bonds returning to a normal energy state, or relaxing. The memory effect shown in FIG. 6 may indicate that changes induced on the water molecules can be impermanent and can have a set lifetime of about 4 hours to about 8 hours. Overall, the data in FIG. 6 indicates that embodiments described herein can be used to alter water flux.

### 4.2. Alterations in Viscosity

Water samples were collected before and after passage through the flow-through magnetic apparatus and the dynamic viscosity was measured. Dynamic viscosity was analyzed because, for example, it represents an experimentally accessible property and for its role in determining water flux as highlighted in the Darcy equation for flux shown in Equation 11:

$$J = {P}_{N e t} / μ {R}_{m} \qquad ( Equation 11 )$$

wherein: J refers to water flux; P_{Net} refers to the pressure drop over a certain distance (Pa); μ refers to dynamic viscosity of the fluid (water, Pa-sec)); and Rₘ refers to the hydraulic resistance of the membrane to water transport (m⁻¹). In some embodiments, Rₘ is about 5.22×10¹⁴ m⁻¹ and P_{Net} is about 26 bar (about 2.6×10⁶ Pa).

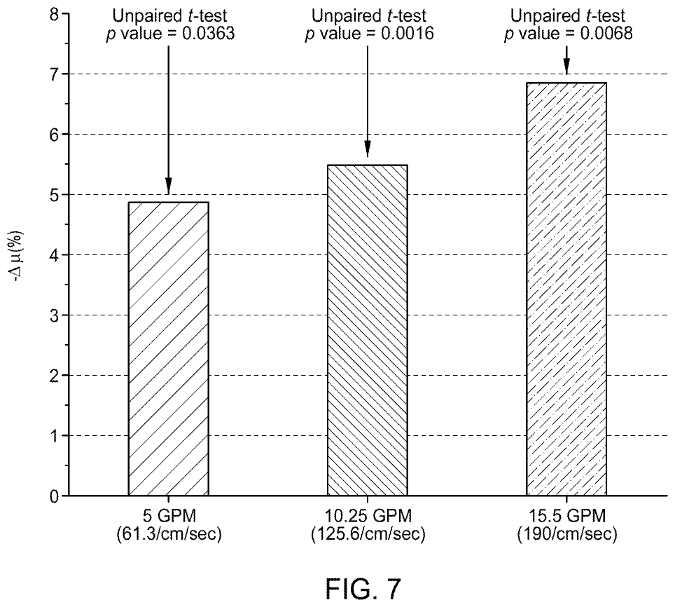

FIG. 7 is a plot of the measured change (decrease) in the dynamic viscosity (−Δμ, %) of ultrapure water (T=20° C., pH=7) after having passed through the flow-through magnetic apparatus at different flow velocities of about 61.3 cm/sec, about 125.6 cm/sec, and about 190 cm/sec relative to ultrapure water that had not passed through the flow-through magnetic apparatus. Water samples were analyzed using a viscometer approximately 30 minutes after having passed through the flow-through magnetic apparatus.

As shown in FIG. 7, water's dynamic viscosity was decreased upon passage through magnetic fields. For example, at a flow velocity of about 61.3 cm/sec, about 125.6 cm/sec, and about 190 cm/sec, the Au value was determined to decrease by about 4.9%, about 5.5%, and about 6.8%, respectively. As the flow velocity increased, the magnitude of the decrease in dynamic viscosity also increased in accordance with measured changes in water permeance across RO membranes as shown in FIG. 5. That is, the magnitude of the decrease in dynamic viscosity increased with increasing flow velocity through the magnetic field. With increases in flow velocity, increased energy can be imparted into the flowing solution.

Also, in alignment with the permeance data shown in FIG. 6, the changes in water dynamic viscosity were temporary and returned to their original (normal) values at a temperature of 20° C. and pH=7. According to Darcy's Law

$$( J = \frac{{P}_{net}}{μ {R}_{m}} ) ,$$

the water permeance

$$( = \frac{J}{{P}_{N e t}} )$$

is an inverse function of the dynamic viscosity of water. Therefore, a decrease in viscosity, while holding other parameters constant, result in an increase in water permeance.

Normally, this may be achieved through increases in water temperature. However, temperature was held constant (T=20° C.) under the conditions tested, indicating that the intramolecular cohesive energies between the water molecules can be altered by passing through the flow-through magnetic apparatus. While not wishing to be bound by theory, this change(s) may have occurred through temporary changes in the nature of the charge distribution across the water molecular structure.

As shown by the data in FIG. 7, the dynamic viscosity of the water can be reduced, relative to the influent reference samples, upon passage through the flow-through magnetic apparatus. This change in dynamic viscosity can increase with increasing flow velocity through the magnetic field in similar fashion to the increase in water flux (FIG. 5). Under the conditions tested, the flux decreased from about 5% to about 7% over the three flow velocities presented in FIG. 7. Overall, the data indicated that embodiments described herein can be used to alter a fluid's dynamic viscosity.

While not wishing to be bound by any theory, the observed relationships between water flux and water viscosity may be explained within the context of the Lorentz Force and considering the dipole nature of water molecules with heterogeneous distribution of charges and their density around the molecules. The Lorentz force is described mathematically according to Equation 12:

$${F}^{\to } = q ( {E}^{\to } + {v}^{\to } \times {B}^{\to } ) \qquad ( Equation 12 )$$

where F^{→} is the Lorentz force, N; q is electric charge, c; E^{→} is electric field vector,

$$\frac{N}{c} ;$$

v^{→} is the velocity,

$$\frac{m}{s} ;$$

and B^{→} is the magnetic field vector, T.

Because the charge and its density on different points of a dipole can differ, the magnitude and direction of the induced Lorentz on them can be different as well. This can hypothetically cause distortions in the charge distribution across the water molecule and, in turn, change how water molecules behave in solution.

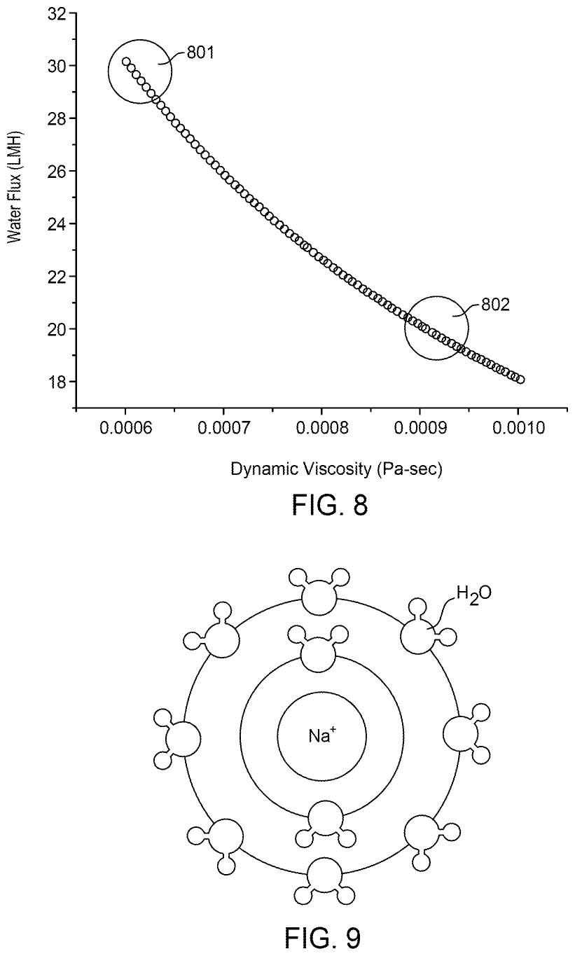

FIG. 8 is a plot showing non-limiting data for water flux versus dynamic viscosity of water after having passed through the flow-through magnetic apparatus according to at least one embodiment of the present disclosure. 801 refers to experimentally measured data and 802 refers to expected measurements based on the decrease in dynamic viscosity alone. The water flux, J, can be calculated by Darcy's law as shown above in Equation 11.

The decrease in dynamic viscosity of the water upon passage through the flow-through magnetic apparatus leads to an unexpectedly high increase in water flux. The results in FIG. 8 may suggest that, upon passing through the flow-through magnetic apparatus, the dipole characteristics of water are altered, resulting in changes to hydrogen bonds and water-water interactions, and manifesting as viscosity. While not wishing to be bound by any theory, the unexpectedly high results may also indicate that passing the water through the flow-through magnetic apparatus results in changes in molecular diffusivity, molecular coordination number (cluster structure), or combinations thereof.

Overall, the data indicated that permeance (LMH/Bar) of a fluid through a selective membrane, such as an RO membrane, can be increased following passage through a magnetic field. The magnitude of the increase can be a function of the fluid's flow velocity and energy imparted by the magnetic field into the fluid. In addition, the dynamic viscosity of a fluid can be reduced by the magnetic field, where the reduction in dynamic viscosity may account for some improvements in permeance. Further, the improvements in permeance result in reductions in process specific energy consumption (kWh/m³) without, for example, added chemical costs or modifications to membrane design.

### 4.3. Alterations in Water-Ion Associations and Ion Permeability

FIG. 9 shows an ion-water complex illustrating solvation shells of a sodium ion (Na⁺) dissolved in a solvent. When the solvent is water (H₂O) as shown in FIG. 9, it is called a hydration shell. The number of solvent molecules surrounding each unit of solute—in this example sodium ion (Na⁺)—is called the hydration number of the solute. Although Na⁺ is illustrated as the solute, other suitable ions such as cations, for example, lithium ion (Li⁺), potassium ion (K⁺), calcium ion (Ca²⁺), magnesium ion (Mg²⁺), and suitable transition metal cations or other cations, as well as anions, for example, hydroxide ion (OH⁻), chloride ion (Cl⁻), sulfate ion (SO₄²⁻) are contemplated, among other ions.

The Gibbs hydration energy change of an ion can be estimated according to Equation 13:

$$Δ {G}_{c a l c} = Δ {G}_{e l e c} + Δ {G}_{u n s y m} \qquad ( Equation 13 )$$

wherein: ΔG_{calc} refers to the estimated change in Gibbs hydration energy; ΔG_{elec} assumes the ion is a charged unit and accounts for electrostatic interactions with the bulk water; and ΔG_{unsym} accounts for unsymmetrical charge effects of cations and anions.

ΔG_{unsym} can be expressed according to Equation 14:

$$Δ {G}_{u n s y m} = 120 {r}^{2} {z}^{3} \qquad ( Equation 14 )$$

wherein: r is the width of a hydration shell (nm); and Z is an ion's charge.

$$Δ {G}_{e l e c} ( \frac{kJ}{mol} )$$

can be expressed according to Equation 15:

$$Δ {G}_{e l e c} = - 64.5 {z}^{2} [ 0.44 ( \frac{Δ r}{r} ) + 0.9 \; 87 ] / ( r + Δ r ) \qquad ( Equation 15 )$$

wherein: r is the width of hydration shell (nm); Δr is width of hydration shell; and Z is the ion's charge.

The Gibbs hydration energy of an ion is associated with ion dehydration. Embodiments of the present disclosure can be utilized to change an ion's hydration (for example, to dehydrate an ion) which occurs when the ion loses a portion of its hydration shell/solvation layers. Removal of these layers can then, in turn, affect the behavior of the ion. The ion can be dehydrated when the target (for example, water and/or solute therein) is exposed to an operational magnetic energy that is greater than a bond energy of the ion with water (for example, Na⁺—H₂O).

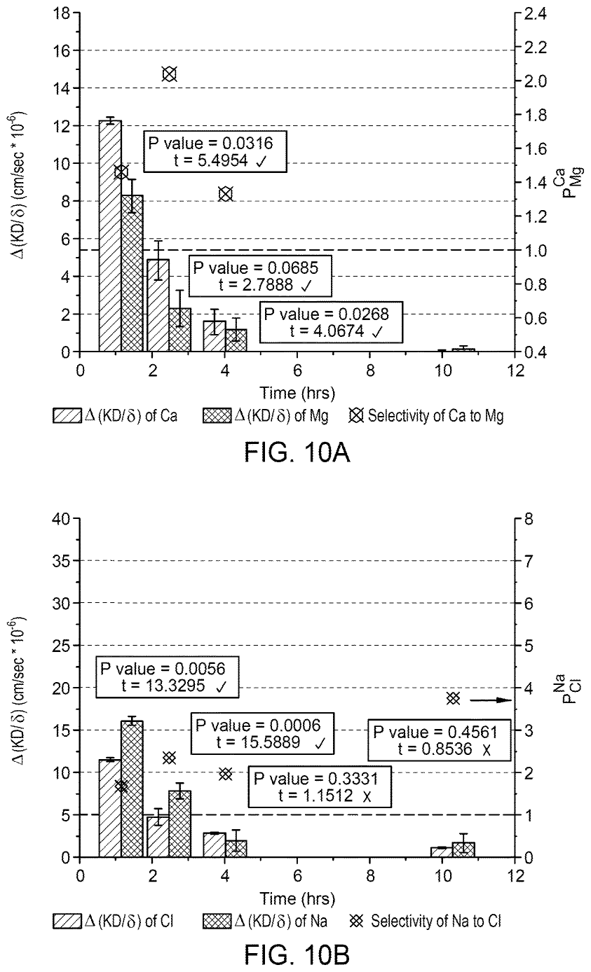

FIGS. 10A and 10B show non-limiting ion permeability data for passage of a mixed electrolyte solution through a SW30HR membrane after exposure of the mixed electrolyte solution to a magnetic field produced by a flow-through magnetic apparatus. The data in FIG. 10A relate to calcium ion and magnesium ion, and the data in FIG. 10B relate to sodium ion and chloride ion. In FIGS. 10A and 10B, Δ(KD/δ) refers to the change in ion permeability from that measured in a control test (having not passed through a magnetic field and is in units of cm/sec×10⁻⁶,

$${P}_{M g}^{C a}$$

refers to ion selectivity, in this case calcium and magnesium, of the membrane delineating which ion (designated on top) more easily permeates across the membrane (unitless);

$${P}_{Cl}^{N a}$$

refers to ion selectivity, in this case sodium and chloride, of the membrane delineating which ion (designated on top) more easily permeates across the membrane (unitless); P value refers to probability of obtaining test results at least as extreme as the result actually observed; and t is the t-statistic

$$( t = \frac{{t}^{-}}{σ \sqrt{n}} )$$

was obtained and compared to the t-statistic values in the t-distribution when having degrees of =n−1. Experiments were run under the following non-limiting conditions: SW30HR membrane; two representative flow velocities of about 46.7 cm/sec or about 42 cm/sec; pressure of about 27.6 bar; temperature of about 20° C.; pH of about 7; and n=3, where n refers to the number of replicate samples.

Passing an electrolyte solution, composed of calcium, magnesium, sodium, and chloride salts, through the magnetic system altered the different ion permeabilities for the SW30HR membrane (FIGS. 10A and 10B). Changes (increases) in permeability values are only reported here for the two highest flow velocities through the magnetic system that were evaluated (42 cm/sec and 46.7 cm/sec). For both the calcium and magnesium in the absence of passing through the magnetic system, their permeability values were approximately 0 cm/s, as would be expected for a tight RO membrane. Therefore, the reported delta permeability values represent the respectively measured permeability values for these cations at the given time periods. The magnitudes of changes in ion permeabilities were determined to be a function of the flow velocity through the magnetic field, ion characteristics, and time after passing through the magnetic fields. Ion permeabilities increased (reduced rejection) with flow velocity through the magnetic fields. Changes in permeability were not permanent as indicated by a reduction in ion permeability, measured for all ions reported here to include calcium, magnesium, sodium, and chloride). These results indicate that the properties of the ions are impermanently modified in a way that enhances their permeabilities across the SW30HR membrane. Changes in ion permeability are proposed to be due to dehydration of the ion thereby resulting a reduction in the hydrated ion diameter thereby reducing the energy penalty that the ion must undergo to pass through the non-porous membrane. Overall, the results shown in FIGS. 10A and 10B indicate that embodiments described herein can be used to alter ion permeability through a membrane.

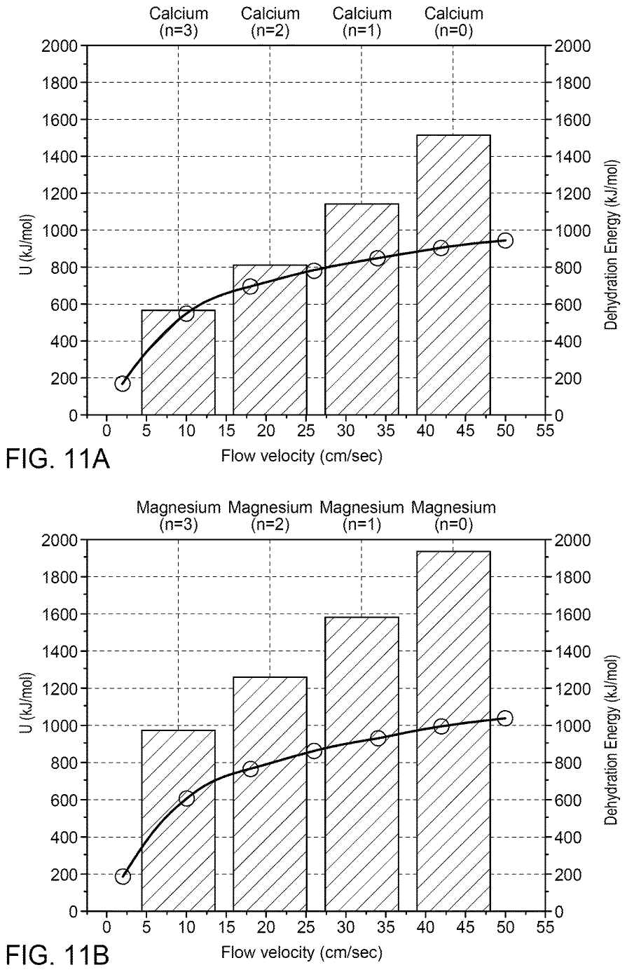

The energy that the ions can be exposed to upon passage through a flow-through magnetic apparatus can be calculated according to Equation 7. Results are shown in FIGS. 11A and 11B along with the theoretical energy suitable to achieve different hydration states. FIGS. 11A and 11B show non-limiting data of magnetic energy (U, shown as open circles) for different ions as a function of flow velocity (primary x-axis on the left) through a flow-through magnetic apparatus according to at least one embodiment of the present disclosure. The data in FIG. 11A relates to calcium ion (Ca²⁺) and the data in FIG. 11B relates to magnesium ion (Mg²⁺). The energies (hatched bars) for calcium or magnesium to achieve different levels of hydration (solvation) are plotted on the secondary x-axis on the right. The bar plots show FIGS. 11A and 11B are not presented as a function of flow velocity, but instead represent the energy for the calcium ion or magnesium ion to achieve the hydration state noted on the secondary x-axis. Experiments were run under at a fluid temperature of 20° C. Table 1 shows selected characteristics for calcium and magnesium ions.

TABLE 1

| | | | | | Gibbs | |
|---|---|---|---|---|---|---|
| | Bare ion | Hydrated | | | hydration | Charge |
| | radius, | radius, | Hydration | Valence | energy, | density, |
| Ion | nm | nm | number | number | kJ/mol | C/mm³ |
| Ca²⁺ | 0.100 | 0.271 | 7.2 | +2 | −1,505 | 52 |
| Mg²⁺ | 0.072 | 0.299 | 10 | +2 | −1,830 | 120 |

In all cases, and under the conditions tested, the U value increased in magnitude with increasing flow velocity. For calcium (FIG. 11A), U approximates the dehydration energy to achieve hydration numbers down to 2 to 1. Under the experimental conditions evaluated here, the U value did not appear to be sufficient to completely dehydrate the cation. Though the U value may not be adequate to fully dehydrate the ion, it imparted energy that would partially dissociate water molecules from the ions, which can reduce the effective size of the ions and subsequently improve the possibility of entering the free volume space of the RO membrane or other media.

The energy approximations between U and the dehydration energies were in less agreement for the magnesium ions (FIG. 11B) despite the observed enhancement in magnesium permeability (from 0 to about 79 cm/sec). The data and model indicates that the energy resulting from passing through the flow-through magnetic apparatus can be sufficient to achieve at least partial dehydration of the studied ions supporting the observed enhancements in permeability across the SW30HR membrane. Overall, changes in ion hydration can be achieved utilizing embodiments of the present disclosure.

Embodiments of the present disclosure generally relate to desalination, and more specifically to apparatus and methods for magnetically assisted desalination. Embodiments described herein can enable increased fluid transport across membranes. As described herein, water transport (flux) across RO membranes can be enhanced by initially passing the feed water through a magnetic field. This increase can occur while maintaining a constant feed pressure, and thus, can be accomplished without the use of additional energy. Therefore, the specific energy consumption of the RO process may be reduced by embodiments described herein. In addition, membrane fouling may be lessened by embodiments described herein.

From a transport perspective, and within the context of the solution-diffusion model, water transport across dense, hydrated membranes can be a function of molecular diffusion. Solvent-polymer interactions can also play a role. Altering the water diffusion and/or its interactions with membrane polymers (for example, polyamide polymers) or even with itself (for example, water-water interactions) may be potential candidates for explaining the enhanced water transport and decline in viscosity observed. These outcomes can be influenced by the flow velocity through the magnetic field, which may be related to an increase in the Lorentz Force that is exerted on the water molecules.

Reductions in, for example, water dynamic viscosity can indicate that intramolecular interactions and/or intermolecular interactions are influenced by passage through the magnetic field and may explain, at least in part, the observed changes in water transport. The examples indicate that embodiments described herein can alter, for example, molecular properties to cause mesoscale effects on transport and solution properties. Results described herein indicate that embodiments of the present disclosure can be utilized to alter the molecular properties, and in turn the mesoscale properties, of a fluid and/or solutes therein.

### Embodiments Listing

The present disclosure provides, among others, the following embodiments, each of which can be considered as optionally including any alternate embodiments:

Clause 1. A desalination apparatus, comprising:
a fluid passage comprising a first end, a second end, and a flow path;
a valve coupled to the first end, the valve for permitting a fluid to enter the flow path;
a device for forming a magnetic field, the device positioned on an exterior of the fluid passage; and
a selective membrane coupled to the second end of the flow path.

Clause 2. The desalination apparatus of Clause 1, wherein the device for forming the magnetic field comprises a plurality of magnets disposed on the exterior of the fluid passage and along the flow path.

Clause 3. The desalination apparatus of Clause 2, wherein the plurality of magnets are positioned in a helical arrangement along the flow path.

Clause 4. The desalination apparatus of any one of Clauses 1-3, wherein the fluid comprises water, salts, ions thereof, or combinations thereof.

Clause 5. The desalination apparatus of any one of Clauses 1-4, wherein the magnetic field is adapted to alter one or more properties of the fluid.

Clause 6. The desalination apparatus of Clause 5, wherein the at least one property comprises a dynamic viscosity, a permeance through the selective membrane, a flux, or combinations thereof.

Clause 7. An apparatus for altering at least one property of a fluid, the apparatus comprising:
a housing through which the fluid is adapted to flow, the housing comprising a first end, a second end, and a channel through which the fluid is configured to flow;
a source of the fluid coupled to the second end of the housing;
a selective membrane through which the fluid is configured to flow, the selective membrane coupled to a second end of the housing; and
a source of magnetic field adapted to change at least one property of the fluid, the source of magnetic field positioned on an exterior of the housing between the first end and the second end.

Clause 8. The apparatus of Clause 7, wherein the at least one property comprises a dynamic viscosity, a permeance through the selective membrane, a flux, or combinations thereof.

Clause 9. The apparatus of Clause 7 or Clause 8, wherein the source of magnetic field is adapted to:
increase the permeance of the fluid through the selective membrane;
decrease the dynamic viscosity of the fluid; or
combinations thereof.

Clause 10. The apparatus of any one of Clauses 7-9, wherein the magnetic field is a multidirectional magnetic field.

Clause 11. The apparatus of any one of Clauses 7-10, wherein the source of magnetic field comprises a plurality of magnets.

Clause 12. The apparatus of Clause 11, wherein the plurality of magnets are positioned in a helical arrangement about the exterior of the housing.

Clause 13. The apparatus of any one of Clauses 7-12, wherein the fluid comprises water, salts, ions thereof, or combinations thereof.

Clause 14. A method for desalinating a fluid, the method comprising:
directing a fluid to flow through a magnetic field, the magnetic field selected to alter one or more properties of the fluid; and
directing the fluid to flow through a selective membrane after directing the fluid to flow through the magnetic field.

Clause 15. The method of Clause 14, wherein:
the one or more properties comprises a dynamic viscosity, a permeance through the selective membrane, a flux, or combinations thereof;
the fluid comprises liquid water, salts, ions thereof, or combinations thereof; or
combinations thereof.

Clause 16. The method of Clause 14 or Clause 15, wherein:
a first measured dynamic viscosity of the fluid is higher than a second measured dynamic viscosity of the fluid after flowing the fluid through the magnetic field;
a first measured permeance of the fluid is lower than a second measured permeance of the fluid after flowing the fluid through the magnetic field; or
combinations thereof.

Clause 17. The method of any one of Clauses 14-16, wherein:
the directing the fluid to flow through the magnetic field comprises introducing the fluid to a channel, the channel having a first end, a second end, and a fluid flow path;
the magnetic field is produced by a source of the magnetic field, the source of the magnetic field positioned on an exterior of the channel, the source of the magnetic field comprising a plurality of magnets positioned on the exterior of the channel and along the fluid flow path.

Clause 18. The method of Clause 17, wherein the plurality of magnets are positioned in a helical arrangement on the exterior of the channel and along the fluid flow path.

Clause 19. The method of any one of Clauses 14-18, wherein the magnetic field is a multidirectional magnetic field.

Clause 20. The method of any one of Clauses 14-19, wherein a strength of the magnetic field is about 0.1 Tesla or more, about 10 Tesla or less, or combinations thereof.

Clause 21. A desalination apparatus comprising:
a fluid passage comprising a first end, a second end, and a flow path connecting the first end with the second end;
a valve coupled to the first end, the valve adapted to permit a fluid to enter the flow path;
a device adapted to form a magnetic field, the device positioned on an exterior of the fluid passage; and
a selective membrane coupled to the second end of the flow path.

Clause 22. The desalination apparatus of Clause 21, wherein the device adapted to form the magnetic field comprises a single magnet or a plurality of magnets disposed on the exterior of the fluid passage and along the flow path.

Clause 23. The desalination apparatus of Clause 22, wherein the plurality of magnets are positioned in a helical arrangement along the flow path.

Clause 24. The desalination apparatus of any one of Clauses 21-23, wherein:
the fluid is a fresh fluid or a recirculated fluid;
the fluid comprises water, a salt, an ion thereof, or combinations thereof, or
combinations thereof.

Clause 25. The desalination apparatus of any one of Clauses 21-4, wherein the magnetic field is adapted to:
alter one or more molecular properties of the fluid, a salt therein, an ion thereof, or combinations thereof;
alter one or more mesoscale properties of the fluid, a salt therein, an ion thereof, or combinations thereof;
transform the fluid, a salt therein, an ion thereof, or combinations thereof;
dehydrate an ion; or
combinations thereof.

Clause 26. The desalination apparatus of Clause 25, wherein:
the one or more molecular properties of the fluid, the salt therein, the ion thereof, or combinations thereof comprises a bond energy, a bond angle, a spin state, an energy state, a polarizability, a hydration shell, or combinations thereof;
the one or more mesoscale properties of the fluid, the salt therein, the ion thereof, or combinations thereof comprises a dynamic viscosity, a permeance through a selective membrane, a flux, a surface tension, a density, a vapor pressure, hydrogen bonding, a viscosity, a permeability, a solubility, a polarity, a pH, a conductivity, a reactivity, a thermal conductivity, an enthalpy, an entropy, a boiling point, a vapor point, or combinations thereof; or
combinations thereof.

Clause 27. The desalination apparatus of Clause 25 or Clause 26, wherein the one or more mesoscale properties of the fluid, the salt therein, the ion thereof, or combinations thereof comprises a dynamic viscosity, a permeance through a selective membrane, a flux, or combinations thereof.

Clause 28. An apparatus adapted to alter at least one property of a fluid, the apparatus comprising:
a housing comprising first end, a second end, and a flow path through which a fluid is adapted to flow, the flow path connecting the first end and the second end;
a magnetic field source positioned on an exterior of the housing between the first end and the second end, the magnetic field source adapted to produce a magnetic field;
a first valve coupled to a first inlet of the first end of the housing, the first valve adapted to permit the fluid to enter the flow path;
a second valve coupled to a first outlet of the second end of the housing, the second valve adapted to permit a magnetically treated fluid to exit the apparatus; and
a recycle line coupled to a second outlet of the second end and to a second inlet of the first end, the recycle line adapted to recirculate the magnetically treated fluid through the flow path.

Clause 29. The apparatus of Clause 28, further comprising a selective membrane coupled to the second valve.

Clause 30. The apparatus of Clause 28 or Clause 29, wherein the magnetic field produced is adapted to:
alter one or more molecular properties of the fluid, a solute therein, or combinations thereof;
alter one or more mesoscale properties of the fluid, a solute therein, or combinations thereof, or
combinations thereof.

Clause 31. The apparatus of Clause 30, wherein:
the one or more molecular properties of the fluid, the solute therein, or combinations thereof comprises a bond energy, a bond angle, a spin state, an energy state, a polarizability, a hydration shell, or combinations thereof;
the one or more mesoscale properties of the fluid, the solute therein, or combinations thereof comprises a dynamic viscosity, a permeance through a selective membrane, a flux, or combinations thereof;
or combinations thereof.

Clause 32. The apparatus of any one of Clauses 28-31, wherein the magnetic field source is adapted to:
increase a permeance of the fluid through a selective membrane;
decrease a dynamic viscosity of the fluid;
increase an energy state of the fluid;
increase a polarizability of the fluid; or
combinations thereof.

Clause 33. The apparatus of any one of Clauses 28-32, wherein the magnetic field produced is a multidirectional magnetic field.

Clause 34. The apparatus of any one of Clauses 28-33, wherein the magnetic field source comprises a single magnet or a plurality of magnets.

Clause 35. The apparatus of Clause 34, wherein the plurality of magnets are positioned in a helical arrangement about the exterior of the housing.

Clause 36. A method for desalinating a fluid, the method comprising:
directing a fluid to flow through a magnetic field;
exposing the fluid, a solute therein, or combinations thereof to the magnetic field to form a treated fluid; and
directing the treated fluid to flow through a selective membrane.

Clause 37. The method of Clause 36, wherein the method further comprises:
adjusting a velocity of the fluid while the fluid is exposed to the magnetic field;
adjusting a strength of the magnetic field while the fluid is exposed to the magnetic field; or
combinations thereof.

Clause 38. The method of Clause 36 or Clause 37, wherein:
a first measured dynamic viscosity of the fluid (measured before exposing the fluid to a magnetic field) is higher than a second measured dynamic viscosity of the treated fluid (measured after exposing the fluid to a magnetic field);
a first measured permeance of the fluid (measured before exposing the fluid to a magnetic field) is lower than a second measured permeance of the treated fluid (measured after exposing the fluid to a magnetic field); or
a first measured energy state of the fluid (measured before exposing the fluid to a magnetic field) is higher than a second measured energy state of the treated fluid (measured after exposing the fluid to a magnetic field);
a first measured polarizability of the fluid (measured before exposing the fluid to a magnetic field) is lower than a second measured polarizability of the treated fluid (measured after exposing the fluid to a magnetic field); or
combinations thereof.

Clause 39. The method of any one of Clauses 36-38, wherein:
the directing the fluid to flow through the magnetic field comprises introducing the fluid to a channel, the channel having a first end, a second end, and a fluid flow path coupling the first end and the second end; and
the magnetic field is produced by a source of the magnetic field, the source of the magnetic field positioned on an exterior of the channel, the source of the magnetic field comprising a single magnet or a plurality of magnets positioned on the exterior of the channel and along the fluid flow path.

Clause 40. The method of any one of Clauses 36-38, wherein a strength of the magnetic field is about 0.1 Tesla or more, about 10 Tesla or less, or combinations thereof.

In the foregoing, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the foregoing aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, such as the terms “comprising,” “consisting essentially of,” “consisting of” also include the product of the combinations of elements listed after the term.

References cited herein are incorporated by reference herein in their entirety to indicate the state of the art as of their publication or filing date and it is intended that this information can be employed herein, if needed, to exclude specific embodiments that are in the prior art.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

For purposes of this present disclosure, and unless otherwise specified, the term “coupled” is used herein to refer to elements that are either directly connected or connected through one or more intervening elements. For example, an opening can be directly connected to a fluid passage, or it can be connected to the fluid passage via intervening elements.

As used herein, the indefinite article “a” or “an” shall mean “at least one” unless specified to the contrary or the context clearly indicates otherwise. For example, embodiments comprising “a magnet” include embodiments comprising one, two, or more magnets, unless specified to the contrary or the context clearly indicates only one magnet is included.

While the foregoing is directed to embodiments of the present disclosure, other and further embodiments of the disclosure may be devised without departing from the basic scope thereof, and the scope thereof is determined by the claims that follow.

What is claimed is:

1. A desalination apparatus comprising:
a fluid passage comprising a first end, a second end, and a flow path connecting the first end with the second end;
a valve coupled to the first end, the valve adapted to permit a fluid to enter the flow path;
a device adapted to form a magnetic field, the device positioned on an exterior of the fluid passage; and
a selective membrane coupled to the second end of the flow path.

2. The desalination apparatus of claim 1, wherein the device adapted to form the magnetic field comprises a single magnet or a plurality of magnets disposed on the exterior of the fluid passage and along the flow path.

3. The desalination apparatus of claim 2, wherein the plurality of magnets are positioned in a helical arrangement along the flow path.

4. The desalination apparatus of claim 1, wherein:
the fluid is a fresh fluid or a recirculated fluid;
the fluid comprises water, a salt, an ion thereof, or combinations thereof, or
combinations thereof.

5. The desalination apparatus of claim 1, wherein the magnetic field is adapted to:
alter one or more molecular properties of the fluid, a salt therein, an ion thereof, or combinations thereof;
alter one or more mesoscale properties of the fluid, a salt therein, an ion thereof, or combinations thereof;
transform the fluid, a salt therein, an ion thereof, or combinations thereof;
dehydrate an ion; or
combinations thereof.

6. The desalination apparatus of claim 5, wherein:
the one or more molecular properties of the fluid, the salt therein, the ion thereof, or combinations thereof comprises a bond energy, a bond angle, a spin state, an energy state, a polarizability, a hydration shell, or combinations thereof;
the one or more mesoscale properties of the fluid, the salt therein, the ion thereof, or combinations thereof comprises a dynamic viscosity, a permeance through a selective membrane, a flux, a surface tension, a density, a vapor pressure, hydrogen bonding, a viscosity, a permeability, a solubility, a polarity, a pH, a conductivity, a reactivity, a thermal conductivity, an enthalpy, an entropy, a boiling point, a vapor point, or combinations thereof, or
combinations thereof.

7. The desalination apparatus of claim 5, wherein the one or more mesoscale properties of the fluid, the salt therein, the ion thereof, or combinations thereof comprises a dynamic viscosity, a permeance through a selective membrane, a flux, or combinations thereof.

8. An apparatus adapted to alter at least one property of a fluid, the apparatus comprising:
a housing comprising first end, a second end, and a flow path through which a fluid is adapted to flow, the flow path connecting the first end and the second end;
a magnetic field source positioned on an exterior of the housing between the first end and the second end, the magnetic field source adapted to produce a magnetic field;
a first valve coupled to a first inlet of the first end of the housing, the first valve adapted to permit the fluid to enter the flow path;
a second valve coupled to a first outlet of the second end of the housing, the second valve adapted to permit a magnetically treated fluid to exit the apparatus; and
a recycle line coupled to a second outlet of the second end and to a second inlet of the first end, the recycle line adapted to recirculate the magnetically treated fluid through the flow path.

9. The apparatus of claim 8, further comprising a selective membrane coupled to the second valve.

10. The apparatus of claim 8, wherein the magnetic field produced is adapted to:
alter one or more molecular properties of the fluid, a solute therein, or combinations thereof;
alter one or more mesoscale properties of the fluid, a solute therein, or combinations thereof; or
combinations thereof.

11. The apparatus of claim 10, wherein:
the one or more molecular properties of the fluid, the solute therein, or combinations thereof comprises a bond energy, a bond angle, a spin state, an energy state, a polarizability, a hydration shell, or combinations thereof;
the one or more mesoscale properties of the fluid, the solute therein, or combinations thereof comprises a dynamic viscosity, a permeance through a selective membrane, a flux, or combinations thereof;
or combinations thereof.

12. The apparatus of claim 8, wherein the magnetic field source is adapted to:
increase a permeance of the fluid through a selective membrane;
decrease a dynamic viscosity of the fluid;
increase an energy state of the fluid;
increase a polarizability of the fluid; or
combinations thereof.

13. The apparatus of claim 8, wherein the magnetic field produced is a multidirectional magnetic field.

14. The apparatus of claim 8, wherein the magnetic field source comprises a single magnet or a plurality of magnets.

15. The apparatus of claim 14, wherein the plurality of magnets are positioned in a helical arrangement about the exterior of the housing.

16. A method for desalinating a fluid, the method comprising:
directing a fluid to flow through a magnetic field;
exposing the fluid, a solute therein, or combinations thereof to the magnetic field to form a treated fluid; and
directing the treated fluid to flow through a selective membrane.

17. The method of claim 16, wherein the method further comprises:
adjusting a velocity of the fluid while the fluid is exposed to the magnetic field;
adjusting a strength of the magnetic field while the fluid is exposed to the magnetic field; or
combinations thereof.

18. The method of claim 16, wherein:
a first measured dynamic viscosity of the fluid is higher than a second measured dynamic viscosity of the treated fluid;
a first measured permeance of the fluid is lower than a second measured permeance of the treated fluid; or
a first measured energy state of the fluid is higher than a second measured energy state of the treated fluid;
a first measured polarizability of the fluid is lower than a second measured polarizability of the treated fluid; or
combinations thereof.

19. The method of claim 16, wherein:
the directing the fluid to flow through the magnetic field comprises introducing the fluid to a channel, the channel having a first end, a second end, and a fluid flow path coupling the first end and the second end; and
the magnetic field is produced by a source of the magnetic field, the source of the magnetic field positioned on an exterior of the channel, the source of the magnetic field comprising a single magnet or a plurality of magnets positioned on the exterior of the channel and along the fluid flow path.

20. The method of claim 16, wherein a strength of the magnetic field is about 0.1 Tesla or more, about 10 Tesla or less, or combinations thereof.
